(19) United States
(12) Patent Application Publication
(10) Pub. No.: US 2026/0347096 A1
(43) Pub. Date: Nov. 5, 2026

(54) COMBINED ROLLER/GRAPPLE DESIGN

(71) Applicant: Haull, Inc., Dover, DE (US)

(72) Inventor: Todd A. Perri, Chapel Hill, NC (US)

(73) Assignee: Haull, Inc., Dover, DE (US)

(21) Appl. No.: 19/711,172

(22) Filed: Jun. 17, 2026

Related U.S. Application Data
(63) Continuation of application No. PCT/US2024/061347, filed on Dec. 20, 2024.
(60) Provisional application No. 63/613,898, filed on Dec. 22, 2023.

(51) Int. Cl. B65F 3/02; B65F 3/20

(52) U.S. Cl. CPC B65F 3/0203; B65F 3/203

(57) ABSTRACT

A combined roller/loader tool includes multiple parts that together form a cylindrically shaped outer surface and a rigid frame. The multiple parts are rotatably connected to the rigid frame and/or to each other. In a closed position, the roller/loader tool acts as a roller compactor. In an open position, the roller/loader tool acts as a waste loader. There are agitators formed on the outer surface of the respective parts of the combined roller/loader tool. The agitators are configured to break apart, shred, and/or compact a bulky waste material when the combined roller/loader tool is in the roller compactor configuration.

### CROSS-REFERENCE TO RELATED APPLICATIONS

This application is a continuation of International Patent Application Serial No. PCT/US2024/061347, which was filed on Dec. 20, 2024, which claims priority to 63/613,898, which was filed Dec. 22, 2023, the entire contents of which are incorporated by reference herein.

### BACKGROUND

Roll-off dumpsters have been used for decades by construction companies, distributors, manufacturers, municipalities, and other commercial users, as well as individuals, to discard bulky waste. These dumpsters, also known as bins or containers, typically have five (5) side walls and an open top and vary in size from a few cubic yards to 50 cubic yards or more. The dumpsters are deposited at, and picked up from, designated locations where waste material is expected to be generated and/or collected by a “roll-off” truck, which maneuvers a single dumpster on or off the truck, typically via a cable or hook. Such trucks transport the waste material to an off-site location (e.g., to a dump site or transfer station). Due to the need for transporting waste materials generated during the regular course of business and also the relative abundance and simple construction of such conventional dumpsters, there are currently a number of companies offering services related to the transport, deployment, and removal of such dumpsters throughout the United States.

There are, however, several disadvantages associated with the use of such known conventional dumpsters. Often, the waste material to be disposed of is bulky in nature and is not capable of being readily neatly and efficiently loaded (e.g., in the form in which it is loaded into the dumpster) into such dumpsters. Thus, it is common at present for “full” dumpsters (e.g., dumpsters that are full up to, over, adjacent to, etc. the top of said dumpster) to contain a large amount of voids (e.g., empty space, or air), meaning that the dumpster will contain less waste material (e.g., by mass) than is indicated by the volume of the dumpster and which could be more readily achieved if the waste material were not as bulky. Thus, for example, a dumpster that has a volume of 30 cubic yards may only be able to transport, for example, 3 tons of waste material instead of, for example, 9 tons if the waste material were capable of being packed more efficiently (e.g., having less voids present) within the dumpster. This is particularly disadvantageous because the voids within the dumpster increase the cost of hauling a unit of measure (e.g., a ton) of the waste material; this increased cost is then passed on to consumers. The reason for the increased costs is because the fixed costs associated with retrieving, transporting, and redeploying a dumpster are largely similar, other than waste disposal fees when charged by unit weight, for a company regardless of whether the dumpster is full, empty, inefficiently packed, etc.

Another disadvantage associated with the use of conventional dumpsters is that, in order to accommodate the waste collection and disposal needs of a multitude of different customers, it is almost universally necessary for a company to offer dumpsters of multiple different sizes (e.g., 10, 20, 30, 40, or 50 cubic yards). However, in order to simplify operational logistics, many companies only operate trucks that are capable of transporting the largest dumpster serviced by the company. Thus, even if the waste material were efficiently loaded into the dumpster, the truck itself is carrying less waste material to the collection or disposal site than the truck is otherwise capable of transporting and, therefore, the truck is underutilized, leading to operating costs per dumpster to be higher than could otherwise be possible with a less bulky waste material. The majority of commercial dumpsters have an internal volume of about 30 cubic yards, even though roll-off trucks, like conventional garbage trucks, are known to be capable of carrying larger dumpsters, which would advantageously yield higher overall operational efficiency (e.g., as measured by ton of waste material transported per mile or trip) of the truck. Such 30 cubic yard dumpsters are most commonly used because, at 6 feet high, laborers can reasonably lift and toss waste into the dumpster. Conversely, the use of taller dumpsters is regarded as being prohibitively difficult for laborers to load, even though taller dumpsters with higher volume would maximize the truck's operational efficiency and, therefore, minimize trips to the dump. As will be described further elsewhere herein, the scope of the subject matter disclosed herein will allow for a truck to transport a larger (e.g., 40, 45, or 50 cubic yard) dumpster to ensure increased operational efficiency.

Still another known disadvantage associated with the use of conventional dumpsters is that, when removing a dumpster from a waste material generation site, the dumpster is often required to be replaced with an empty dumpster in almost exactly the same spot, whether because of municipal codes specifying acceptable dumpster locations; enclosures that are built to limit public access to the dumpsters; the waste material being loaded into the dumpster in an automated, or semi-automated, manner, such as in a factory, for example; or because of the location of the dumpster adjacent to where the waste material is generated. The removal and replacement of conventional dumpsters is both time-consuming and inefficient, generally requiring the truck to carry an empty dumpster to the waste material generating site, deposit the empty dumpster at a first location away from the full dumpster (e.g., so as to not block the truck's path to access the full dumpster, which is to be removed), move (e.g., by pulling and/or sliding) the full dumpster onto the truck, deposit the full dumpster at a second location away from the empty dumpster (e.g., neither at the first location or at a position that would block the truck's path to access the empty dumpster being deposited in the position from which the full dumpster was retrieved), again move (e.g., by pulling and/or sliding) the empty dumpster onto the truck, deposit the empty dumpster in the position from which the full dumpster was retrieved, and move (e.g., by pulling and/or sliding) the full dumpster onto the truck again for transport of the waste material to the specified disposal and/or collection site.

Conventional (i.e., open-top) dumpsters are expensive and it is often necessary for a plurality of such dumpsters to be provided at a waste material generating site. The cost of these dumpsters is often passed on to customers of the company generating the waste material. Additionally, in order to provide a conventional dumpster with a 30 cubic yard volume while having a height that is no more than 6 feet, such conventional dumpsters have lengths of between 20-24 feet, inclusive. However, the use of dumpsters with such a length can be disadvantageous, limiting the locations in which such conventional dumpsters can be deployed. Further, most bulky waste materials do not require a dumpster to have such a length and can be deposited in a dumpster having a much shorter length. As noted elsewhere herein, however, the need at present for known waste transport and compaction systems to physically transport the dumpster renders the use of such smaller dumpsters to be economically disfavored due to lower truck operational efficiency, since only one dumpster can be transported at the same time, regardless of the size/volume of the dumpster itself. However, given the opportunity for deploying smaller dumpsters at more waste collection/generation locations, a need exists at present to address this deficiency of such known waste transport and compaction systems.

Conventional waste transport and compaction systems also suffer from an inherent operational inefficiency from the fact that, once emptied (e.g., at a waste aggregation or collection site), the empty dumpsters must be transported back to a waste collection/generation locations (e.g., the same or different location) for redeployment and further waste collection activities. This requirement of transporting each conventional dumpster while empty from the waste aggregation or collection site to a waste collection/generation location is highly inefficient.

Thus, a need exists at present that will address many of the disadvantages associated with the use of known conventional dumpsters used in the storage, transport, and disposal of waste materials that are so commonly used at present. The foregoing disclosure will show how the subject matter disclosed herein addresses (e.g., reduces and/or eliminates entirely) the deficiencies associated with such known dumpsters.

### SUMMARY

According to an example, a combined roller/loader tool is provided herein, the combined roller/loader tool comprising: a first part that is substantially hemicylindrically-shaped and has an outer circumferential surface; a second part that is substantially hemicylindrically-shaped and has an outer circumferential surface; and a rigid frame; wherein the first part and the second part are both rotatably connected to the rigid frame; wherein, when the first part and the second part are in a closed position, the combined roller/loader tool is configured as a roller compactor, the outer circumferential surface of the first part and the outer circumferential surface of the second part forming a shape that is substantially cylindrical and the first and second parts rotate together in unison to break apart, shred, and/or compact waste material; and wherein, when the first part and the second part are in an open position, the combined roller/loader tool is configured as a waste loader, the first part and the second part being rotated relative to each other to form a gap between edges of the outer circumferential surfaces of the first and second parts, the first and second parts being configured to rotate from the open position towards the closed position to engage the waste material within a volume defined internal to the first and second parts and/or to hold the waste material between the edges of the outer circumferential surfaces of the first and second parts in a direction of rotation from the open position to the closed position.

According to any of the examples of the combined roller/loader tools disclosed herein, the first part has a radius that is smaller than a radius of the second part.

According to any of the examples of the combined roller/loader tools disclosed herein, the first part, in moving from the closed position to the open position, rotates radially inside the second part.

According to any of the examples of the combined roller/loader tools disclosed herein, the outer circumferential edge of the first part and the outer circumferential edge of the second part both extend circumferentially to each define at least 180° of the substantially cylindrical shape formed by the first and second parts when in the closed position.

According to any of the examples of the combined roller/loader tools disclosed herein, the outer circumferential surface of the first part comprises agitators rigidly attached thereto; the outer circumferential surface of the second part comprises agitators rigidly attached thereto; and the agitators of the first and second parts are configured to break apart, shred, and/or compact the waste material.

According to any of the examples of the combined roller/loader tools disclosed herein, the first part comprises end plates that are attached to the outer circumferential surface of the first part at opposing longitudinal ends of the outer circumferential surface thereof; and the second part comprises end plates that are attached to the outer circumferential surface of the second part at opposing longitudinal ends of the outer circumferential surface thereof.

According to any of the examples of the combined roller/loader tools disclosed herein, the first and second parts each have a radially extending wall at each of the longitudinal ends thereof, the radially extending wall extending beyond the agitators of the first and second parts, respectively, to prevent the agitators from contacting a surface of a waste collection container or dumpster while the combined roller/loader tool is being used as the roller compactor in the closed position.

According to any of the examples of the combined roller/loader tools disclosed herein, the end plates of the first part have a cut-out section; the end plates of the second part have a cut-out section; and the cut-out section of the first part is a different size and/or shape than the cut-out section of the second part; or the cut-out section of the first part is a same size and/or shape as the cut-out section of the second part.

According to any of the examples of the combined roller/loader tools disclosed herein, the cut-out section of the first part and the cut-out section of the second part are aligned with each other such that, when the first and second parts are in the closed position, the cut-out section of the first part and the cut-out section of the second part form a substantially continuous recess.

According to any of the examples of the combined roller/loader tools disclosed herein, the recess is shaped such that handles of a container can be secured within the recess formed by the end plates of the first and second parts when the first and second parts are in the closed position.

According to any of the examples disclosed herein, the combined roller/loader tool can comprise a first actuator attached to the first part, wherein the first actuator is configured to pivotably move or rotate the first part about an axis of rotation; and a second actuator attached to the second part, wherein the second actuator is configured to pivotably move or rotate the second part about the axis of rotation.

According to any of the examples of the combined roller/loader tools disclosed herein, the first actuator is an electric motor or a hydraulic motor; and the second actuator is an electric motor or a hydraulic motor.

According to any of the examples of the combined roller/loader tools disclosed herein, the first actuator is connected directly to the first part; and the second actuator is connected directly to the second part.

According to any of the examples of the combined roller/loader tools disclosed herein, the first actuator is connected indirectly to the first part; and the second actuator is connected indirectly to the second part.

According to any of the examples of the combined roller/loader tools disclosed herein, the first actuator is connected to the first part by a chain; and the second actuator is connected to the second part by a chain.

According to any of the examples of the combined roller/loader tools disclosed herein, the first and second actuators are controlled independently of each other; or the first and second actuators are controlled to move in unison with each other.

According to another example, an arm is disclosed herein, the arm comprising, attached at a mobile end of the articulating arm, a combined roller/loader tool according to any of the examples disclosed herein.

According to any of the examples of the arms disclosed herein, the arm comprises a plurality of arm segments.

According to any of the examples of the arms disclosed herein, the plurality of arm segments are one or more of telescoping arm segments or articulating arm segments.

According to another example, a waste collection container that is substantially rigid and the arm of any of the examples disclosed herein is disclosed, wherein the combined roller/loader tool is configured for selective use as: the roller compactor to break apart, shred, and/or compact the bulky waste material in the waste collection container; and the waste loader to move the bulky waste material into the waste collection container and/or remove the bulky waste material from the waste collection container.

According to any of the examples of the waste collection containers disclosed herein, the arm is fixedly and/or pivotably attached to the waste collection container, so that the arm cannot move in a translatory manner relative to the waste collection container.

According to any of the examples of the waste collection containers disclosed herein, the arm is attached to the waste collection container in a mobile manner.

According to any of the examples of the waste collection containers disclosed herein, the mobile manner in which the arm is attached to the waste collection container comprises a mobile platform that is movable at least along a length of the waste collection container.

According to any of the examples of the waste collection containers disclosed herein, the arm is rotatable and/or pivotable relative to the mobile platform.

According to any of the examples of the waste collection containers disclosed herein, the mobile platform can move the arm along an entirety of the length of the waste collection container.

According to another example, a mobile waste system comprising a transport truck and the waste collection container according to any of the examples disclosed herein is disclosed, wherein the waste collection container is attached to the transport truck.

According to another example, a mobile waste system comprising a transport truck and the waste collection container according to any of the examples disclosed herein is disclosed, wherein the arm is fixedly and/or pivotably attached to the transport truck, so that the arm cannot move in a translatory manner relative to the transport truck.

According to any of the examples of the mobile waste systems disclosed herein, the arm is attached to a frame of the transport truck, at a position that is between the waste collection container and a passenger cabin of the transport truck.

According to any of the examples of the mobile waste systems disclosed herein, the arm is attached directly to the frame of the transport truck.

According to another example, a mobile waste system comprising a transport truck and the arm according to any of the examples disclosed herein is disclosed, wherein the arm is attached to the transport truck and the mobile waste system is configured to selectively use the combined roller/loader tool as: the roller compactor to break apart, shred, and/or compact a bulky waste material in a waste collection container; and the waste loader to move the bulky waste material into the waste collection container and/or remove the bulky waste material from the waste collection container.

According to any of the examples of the mobile waste systems disclosed herein, the arm is fixedly and/or pivotably attached to the transport truck, so that the arm cannot move in a translatory manner relative to the transport truck.

According to any of the examples of the mobile waste systems disclosed herein, the arm is attached to a frame of the transport truck.

According to any of the examples of the mobile waste systems disclosed herein, the arm is attached directly to the frame of the transport truck.

According to another example, a combined roller/loader tool is disclosed herein, the combined roller/loader tool comprising: a first part that is substantially hemicylindrically-shaped and has an outer circumferential surface; a second part that has a shape of a quarter cylinder and has an outer circumferential surface; a third part that has a shape of a quarter cylinder and has an outer circumferential surface; and a rigid frame; wherein the second and third parts are each pivotably attached to the first part and movable into and between a closed position, in which the combined roller/loader is configured as a roller compactor, and an open position, in which the combined roller/loader is configured as a waste loader or grapple; wherein the first part is rotatably connected to the rigid frame, such that the first, second, and third parts rotate about a common axis of rotation in unison with each other; wherein, when the second part and the third part are in the closed position and the combined roller/loader tool is configured as the roller compactor: the outer circumferential surface of the first part, the outer circumferential surface of the second part, and the outer circumferential surface of the third part together form a shape that is substantially cylindrical; and the first, second, and third parts are configured to rotated together in unison to break apart, shred, and/or compact a bulky waste material; and wherein, when the second part and the third part are in the open position and the combined roller/loader tool is configured as the waste loader: the second part and the third part are each rotated relative to the first part to form a gap between adjacent edges of the outer circumferential surfaces of the second and third parts; and the second and third parts are configured to rotate from the open position towards the closed position to engage the waste material within a volume defined internal to the first, second, and third parts and/or to hold the waste material between the edges of the outer circumferential surfaces of the second and third parts in a direction of rotation from the open position to the closed position.

According to any of the examples of the combined roller/loader tools disclosed herein, the second and third parts each have a radius that is smaller than a radius of the first part.

According to any of the examples of the combined roller/loader tools disclosed herein, the second and third parts, in moving from the closed position to the open position, both rotate radially inside the first part.

According to any of the examples of the combined roller/loader tools disclosed herein, in rotating radially inside the first part, the second and third parts rotate in opposite directions from each other.

According to any of the examples of the combined roller/loader tools disclosed herein, the opposite directions are clockwise and anticlockwise.

According to any of the examples of the combined roller/loader tools disclosed herein, the outer circumferential edge of the first part extends circumferentially to define about 180° of the substantially cylindrical shape; the outer circumferential edge of the second part extends circumferentially to define about 90° of the substantially cylindrical shape; and the outer circumferential edge of the third part extends circumferentially to define about 90° of the substantially cylindrical shape.

According to any of the examples of the combined roller/loader tools disclosed herein, when in the closed position, the outer circumferential edge of the first part, the outer circumferential edge of the second part, and the outer circumferential edge of the third part together extend over at least 330°.

According to any of the examples of the combined roller/loader tools disclosed herein, when in the closed position, the outer circumferential edge of the first part, the outer circumferential edge of the second part, and the outer circumferential edge of the third part together extend over about 360°.

According to any of the examples of the combined roller/loader tools disclosed herein, the outer circumferential surface of the first part comprises agitators rigidly attached thereto; the outer circumferential surface of the second part comprises agitators rigidly attached thereto; the outer circumferential surface of the third part comprises agitators rigidly attached thereto; and the agitators of the first, second, and third parts are configured to break apart, shred, and/or compact the waste material.

According to any of the examples of the combined roller/loader tools disclosed herein, the first part comprises end plates that are attached to the outer circumferential surface of the first part at opposing longitudinal ends of the outer circumferential surface thereof; the second part comprises end plates that are attached to the outer circumferential surface of the second part at opposing longitudinal ends of the outer circumferential surface thereof; and the third part comprises end plates that are attached to the outer circumferential surface of the third part at opposing longitudinal ends of the outer circumferential surface thereof.

According to any of the examples of the combined roller/loader tools disclosed herein, the first, second, and third parts each have a radially extending wall at each of the longitudinal ends thereof, the radially extending wall extending beyond the agitators of the first, second, and third parts, respectively, to prevent the agitators from contacting a surface of a waste collection container or dumpster while the combined roller/loader tool is being used as the roller compactor in the closed position.

According to any of the examples of the combined roller/loader tools disclosed herein, the end plates of the second part have a cut-out section; the end plates of the third part have a cut-out section; and the cut-out section of the second part is a different size and/or shape than the cut-out section of the third part; or the cut-out section of the second part is a same size and/or shape as the cut-out section of the third part.

According to any of the examples of the combined roller/loader tools disclosed herein, the cut-out section of the second part and the cut-out section of the third part are aligned with each other such that, when the second and third parts are in the closed position, the cut-out section of the second part and the cut-out section of the third part form a substantially continuous recess.

According to any of the examples of the combined roller/loader tools disclosed herein, the recess is shaped such that handles of a container can be secured within the recess formed by the end plates of the second and third parts when the second and third parts are in the closed position.

According to any of the examples of the combined roller/loader tools disclosed herein, the combined roller/loader can comprise: a first actuator attached, at a first end, to the first part and, at a second end, to the second part, wherein the first actuator is configured to pivotably move or rotate the second part relative to the first part; and a second actuator attached, at a first end, to the first part and, at a second end, to the third part, wherein the second actuator is configured to pivotably move or rotate the third part relative to the first part.

According to any of the examples of the combined roller/loader tools disclosed herein, the first actuator is a linear actuator that pivotably moves the second part relative to the first part by changing a length of the first actuator; and the second actuator is a linear actuator that pivotably moves the third part relative to the first part by changing a length of the second actuator.

According to any of the examples of the combined roller/loader tools disclosed herein, the first actuator and the second actuator are each a hydraulic, pneumatic, or electric linear actuator.

According to any of the examples of the combined roller/loader tools disclosed herein, the first and second actuators are controlled independently of each other; or the first and second actuators are controlled to move in unison with each other.

According to another example, an arm is disclosed herein, the arm comprising, attached at a mobile end of the articulating arm, a combined roller/loader tool according to any of the examples disclosed herein.

According to any of the examples of the arms disclosed herein, the arm comprises a plurality of arm segments.

According to any of the examples of the arms disclosed herein, the plurality of arm segments are one or more of telescoping arm segments or articulating arm segments.

According to another example, a waste collection container that is substantially rigid and the arm of any of the examples disclosed herein is disclosed, wherein the combined roller/loader tool is configured for selective use as: the roller compactor to break apart, shred, and/or compact the waste material in the waste collection container; and the waste loader to move the bulky waste material into the waste collection container and/or remove the bulky waste material from the waste collection container.

According to any of the examples of the waste collection containers disclosed herein, the arm is fixedly and/or pivotably attached to the waste collection container, so that the arm cannot move in a translatory manner relative to the waste collection container.

According to any of the examples of the waste collection containers disclosed herein, the arm is attached to the waste collection container in a mobile manner.

According to any of the examples of the waste collection containers disclosed herein, the mobile manner in which the arm is attached to the waste collection container comprises a mobile platform that is movable at least along a length of the waste collection container.

According to any of the examples of the waste collection containers disclosed herein, the arm is rotatable and/or pivotable relative to the mobile platform.

According to any of the examples of the waste collection containers disclosed herein, the mobile platform can move the arm along an entirety of the length of the waste collection container.

According to another example, a mobile waste system comprising a transport truck and the waste collection container according to any of the examples disclosed herein is disclosed, wherein the waste collection container is attached to the transport truck.

According to another example, a mobile waste system comprising a transport truck and the waste collection container according to any of the examples disclosed herein is disclosed, wherein the arm is fixedly and/or pivotably attached to the transport truck, so that the arm cannot move in a translatory manner relative to the transport truck.

According to any of the examples of the mobile waste systems disclosed herein, the arm is attached to a frame of the transport truck, at a position that is between the waste collection container and a passenger cabin of the transport truck.

According to any of the examples of the mobile waste systems disclosed herein, the arm is attached directly to the frame of the transport truck.

According to another example, a mobile waste system comprising a transport truck and the arm according to any of the examples disclosed herein is disclosed, wherein the arm is attached to the transport truck and the mobile waste system is configured to selectively use the combined roller/loader tool as: the roller compactor to break apart, shred, and/or compact a bulky waste material in a waste collection container; and the waste loader to move the bulky waste material into the waste collection container and/or remove the bulky waste material from the waste collection container.

According to any of the examples of the mobile waste systems disclosed herein, the arm is fixedly and/or pivotably attached to the transport truck, so that the arm cannot move in a translatory manner relative to the transport truck.

According to any of the examples of the mobile waste systems disclosed herein, the arm is attached to a frame of the transport truck.

According to any of the examples of the mobile waste systems disclosed herein, the arm is attached directly to the frame of the transport truck.

According to another example, a method of using a combined roller/loader tool to selectively compact and move a bulky waste material is disclosed, the method comprising: attaching a first part that is substantially hemicylindrically-shaped and a second part that is substantially hemicylindrically-shaped to a rigid frame, wherein the first part has an outer circumferential surface and the second part has an outer circumferential surface; rotating the first part and the second part into a closed position, in which the combined roller/loader tool is operable as a roller compactor, such that the outer circumferential surface of the first part and the outer circumferential surface of the second part forming a shape that is substantially cylindrical; rotating, while the first and second parts are in the closed position, the first and second parts together in unison to break apart, shred, and/or compact waste material; rotating the first part and the second part into or towards an open position, in which the first part and the second part form a gap between edges of the outer circumferential surfaces of the first and second parts, wherein, when the first and second parts are not in the closed position, the combined roller/loader tool is operable as a waste loader; and rotating, while the first and second parts are not in the closed position, the first and second parts relative to each other between the open and closed positions to engage the waste material within a volume defined internal to the first and second parts and/or to hold the waste material between the edges of the outer circumferential surfaces of the first and second parts in a direction of rotation from the open position to the closed position.

According to any of the examples of the methods disclosed herein, the first part has a radius that is smaller than a radius of the second part.

According to any of the examples of the methods disclosed herein, the first part, in moving from the closed position to the open position, rotates radially inside the second part.

According to any of the examples of the methods disclosed herein, the outer circumferential edge of the first part and the outer circumferential edge of the second part both extend circumferentially to each define at least 180° of the substantially cylindrical shape formed by the first and second parts when in the closed position.

According to any of the examples of the methods disclosed herein, the outer circumferential surface of the first part comprises agitators rigidly attached thereto; the outer circumferential surface of the second part comprises agitators rigidly attached thereto; and the agitators of the first and second parts are used to break apart, shred, and/or compact the waste material.

According to any of the examples of the methods disclosed herein, the first part comprises end plates that are attached to the outer circumferential surface of the first part at opposing longitudinal ends of the outer circumferential surface thereof; and the second part comprises end plates that are attached to the outer circumferential surface of the second part at opposing longitudinal ends of the outer circumferential surface thereof.

According to any of the examples of the methods disclosed herein, the first and second parts each have a radially extending wall at each of the longitudinal ends thereof, the radially extending wall extending beyond the agitators of the first and second parts, respectively, to prevent the agitators from contacting a surface of a waste collection container or dumpster while the combined roller/loader tool is being used as the roller compactor in the closed position.

According to any of the examples of the methods disclosed herein, the end plates of the first part have a cut-out section; the end plates of the second part have a cut-out section; and the cut-out section of the first part is a different size and/or shape than the cut-out section of the second part; or the cut-out section of the first part is a same size and/or shape as the cut-out section of the second part.

According to any of the examples of the methods disclosed herein, the cut-out section of the first part and the cut-out section of the second part are aligned with each other such that, when the first and second parts are in the closed position, the cut-out section of the first part and the cut-out section of the second part form a substantially continuous recess.

According to any of the examples of the methods disclosed herein, the recess is shaped such that handles of a container can be secured within the recess formed by the end plates of the first and second parts when the first and second parts are in the closed position.

According to any of the examples disclosed herein, the method can comprise: attaching a first actuator to the first part; attaching a second actuator to the second part; using the first actuator to pivotably move or rotate the first part about an axis of rotation; and using the second actuator to pivotably move or rotate the second part about the axis of rotation.

According to any of the examples of the methods disclosed herein, the first actuator is an electric motor or a hydraulic motor; and the second actuator is an electric motor or a hydraulic motor.

According to any of the examples of the methods disclosed herein, the first actuator is connected directly to the first part; and the second actuator is connected directly to the second part.

According to any of the examples of the methods disclosed herein, the first actuator is connected indirectly to the first part; and the second actuator is connected indirectly to the second part.

According to any of the examples of the methods disclosed herein, the first actuator is connected to the first part by a chain; and the second actuator is connected to the second part by a chain.

According to any of the examples of the methods disclosed herein, the first and second actuators are controlled independently of each other; or the first and second actuators are controlled to move in unison with each other.

According to any of the examples disclosed herein, the method can comprise attaching the combined roller/loader tool at a mobile end of an articulating arm.

According to any of the examples of the methods disclosed herein, the arm comprises a plurality of arm segments.

According to any of the examples of the methods disclosed herein, the plurality of arm segments are one or more of telescoping arm segments or articulating arm segments.

According to any of the examples disclosed herein, the method can comprise selectively using the arm and the combined roller/loader tool as: the roller compactor to break apart, shred, and/or compact a bulky waste material in a waste collection container that is substantially rigid; and the waste loader to move the bulky waste material into the waste collection container and/or remove the bulky waste material from the waste collection container.

According to any of the examples disclosed herein, the method can comprise fixedly and/or pivotably attaching the arm to the waste collection container, so that the arm cannot move in a translatory manner relative to the waste collection container.

According to any of the examples disclosed herein, the method can comprise attaching the arm to the waste collection container in a mobile manner.

According to any of the examples of the methods disclosed herein, the mobile manner in which the arm is attached to the waste collection container comprises a mobile platform, the method comprising moving the mobile platform at least along a length of the waste collection container.

According to any of the examples disclosed herein, the method can comprise rotating and/or pivoting the arm relative to the mobile platform.

According to any of the examples disclosed herein, the method can comprise using the mobile platform to move the arm along an entirety of the length of the waste collection container.

According to any of the examples disclosed herein, the method can comprise attaching the waste collection container to a transport truck.

According to any of the examples disclosed herein, the method can comprise fixedly and/or pivotably attaching the arm to a transport truck, so that the arm cannot move in a translatory manner relative to the transport truck.

According to any of the examples of the methods disclosed herein, the arm is attached to a frame of the transport truck, at a position that is between the waste collection container and a passenger cabin of the transport truck.

According to any of the examples of the methods disclosed herein, the arm is attached directly to the frame of the transport truck.

According to any of the examples disclosed herein, the method can comprise attaching the arm to a transport truck; and selectively using the combined roller/loader tool as: the roller compactor to break apart, shred, and/or compact a bulky waste material in a waste collection container; and the waste loader to move the bulky waste material into the waste collection container and/or remove the bulky waste material from the waste collection container.

According to any of the examples of the methods disclosed herein, the arm is fixedly and/or pivotably attached to the transport truck, so that the arm cannot move in a translatory manner relative to the transport truck.

According to any of the examples of the methods disclosed herein, the arm is attached to a frame of the transport truck.

According to any of the examples of the methods disclosed herein, the arm is attached directly to the frame of the transport truck.

According to another example, a method of using a combined roller/loader tool to selectively compact and move a bulky waste material is disclosed herein, the method comprising: pivotably attaching a first part, which is substantially hemicylindrically-shaped and has an outer circumferential surface, to a rigid frame; pivotably attaching a second part, which has a shape of a quarter cylinder and has an outer circumferential surface, to the first part; pivotably attaching a third part, which has a shape of a quarter cylinder and has an outer circumferential surface, to the first part; pivoting or rotating the second and third parts, respectively and relative to the first part, into and between a closed position, in which the combined roller/loader tool can be used as a roller compactor, and an open position, in which the combined roller/loader tool is configured as a waste loader or grapple; wherein the first part is rotatably connected to the rigid frame, such that the first, second, and third parts rotate about a common axis of rotation in unison with each other; wherein, when the second part and the third part are in the closed position and the combined roller/loader tool is configured as the roller compactor: the outer circumferential surface of the first part, the outer circumferential surface of the second part, and the outer circumferential surface of the third part together form a shape that is substantially cylindrical; and the first, second, and third parts rotate together in unison to break apart, shred, and/or compact a bulky waste material; and wherein, when the second part and the third part are in the open position and the combined roller/loader tool is configured as the waste loader: the second part and the third part are each rotated relative to the first part to form a gap between adjacent edges of the outer circumferential surfaces of the second and third parts; and the second and third parts rotate from the open position towards the closed position to engage the waste material within a volume defined internal to the first, second, and third parts and/or to hold the waste material between the edges of the outer circumferential surfaces of the second and third parts in a direction of rotation from the open position to the closed position.

According to any of the examples of the methods disclosed herein, the second and third parts each have a radius that is smaller than a radius of the first part.

According to any of the examples of the methods disclosed herein, the second and third parts, in moving from the closed position to the open position, both rotate radially inside the first part.

According to any of the examples of the methods disclosed herein, in rotating radially inside the first part, the second and third parts rotate in opposite directions from each other.

According to any of the examples of the methods disclosed herein, the opposite directions are clockwise and anticlockwise.

According to any of the examples of the methods disclosed herein, the outer circumferential edge of the first part extends circumferentially to define about 180° of the substantially cylindrical shape; the outer circumferential edge of the second part extends circumferentially to define about 90° of the substantially cylindrical shape; and the outer circumferential edge of the third part extends circumferentially to define about 90° of the substantially cylindrical shape.

According to any of the examples of the methods disclosed herein, when in the closed position, the outer circumferential edge of the first part, the outer circumferential edge of the second part, and the outer circumferential edge of the third part together extend over at least 330°.

According to any of the examples of the methods disclosed herein, when in the closed position, the outer circumferential edge of the first part, the outer circumferential edge of the second part, and the outer circumferential edge of the third part together extend over about 360°.

According to any of the examples of the methods disclosed herein, the outer circumferential surface of the first part comprises agitators rigidly attached thereto; the outer circumferential surface of the second part comprises agitators rigidly attached thereto; the outer circumferential surface of the third part comprises agitators rigidly attached thereto; and when the second and third parts are in the closed position, the agitators of the first, second, and third parts to break apart, shred, and/or compact the waste material.

According to any of the examples of the methods disclosed herein, the first part comprises end plates that are attached to the outer circumferential surface of the first part at opposing longitudinal ends of the outer circumferential surface thereof; the second part comprises end plates that are attached to the outer circumferential surface of the second part at opposing longitudinal ends of the outer circumferential surface thereof; and the third part comprises end plates that are attached to the outer circumferential surface of the third part at opposing longitudinal ends of the outer circumferential surface thereof.

According to any of the examples of the methods disclosed herein, the first, second, and third parts each have a radially extending wall at each of the longitudinal ends thereof, the radially extending wall extending beyond the agitators of the first, second, and third parts, respectively, to prevent the agitators from contacting a surface of a waste collection container or dumpster while the combined roller/loader tool is being used as the roller compactor in the closed position.

According to any of the examples of the methods disclosed herein, the end plates of the second part have a cut-out section; the end plates of the third part have a cut-out section; and the cut-out section of the second part is a different size and/or shape than the cut-out section of the third part; or the cut-out section of the second part is a same size and/or shape as the cut-out section of the third part.

According to any of the examples of the methods disclosed herein, the cut-out section of the second part and the cut-out section of the third part are aligned with each other such that, when the second and third parts are in the closed position, the cut-out section of the second part and the cut-out section of the third part form a substantially continuous recess.

According to any of the examples of the methods disclosed herein, the recess is shaped such that handles of a container can be secured within the recess formed by the end plates of the second and third parts when the second and third parts are in the closed position.

According to any of the examples disclosed herein, the method can comprise attaching a first end of a first actuator to the first part and a second end of the first actuator to the second part; attaching a first end of a second actuator to the first part and a second end of the second actuator to the third part; using the first actuator to pivotably move or rotate the second part relative to the first part; and using the second actuator to pivotably move or rotate the third part relative to the first part.

According to any of the examples of the methods disclosed herein, the first actuator is a linear actuator that pivotably moves the second part relative to the first part by changing a length of the first actuator; and the second actuator is a linear actuator that pivotably moves the third part relative to the first part by changing a length of the second actuator.

According to any of the examples of the methods disclosed herein, the first actuator and the second actuator are each a hydraulic, pneumatic, or electric linear actuator.

According to any of the examples of the methods disclosed herein, the first and second actuators are controlled independently of each other; or the first and second actuators are controlled to move in unison with each other.

According to any of the examples disclosed herein, the method can comprise attaching the combined roller/loader tool at a mobile end of an articulating arm.

According to any of the examples of the methods disclosed herein, the arm comprises a plurality of arm segments.

According to any of the examples of the methods disclosed herein, the plurality of arm segments are one or more of telescoping arm segments or articulating arm segments.

According to any of the examples disclosed herein, the method can comprise selectively using the combined roller/loader tool as:
the roller compactor to break apart, shred, and/or compact the waste material in the waste collection container; and
the waste loader to move the bulky waste material into the waste collection container and/or remove the bulky waste material from the waste collection container.

According to any of the examples disclosed herein, the method can comprise fixedly and/or pivotably attaching the arm to the waste collection container, so that the arm cannot move in a translatory manner relative to the waste collection container.

According to any of the examples disclosed herein, the method can comprise attaching the arm to the waste collection container in a mobile manner.

According to any of the examples of the methods disclosed herein, the mobile manner in which the arm is attached to the waste collection container comprises a mobile platform, the method comprising moving the mobile platform at least along a length of the waste collection container.

According to any of the examples disclosed herein, the method can comprise rotating and/or pivoting the arm relative to the mobile platform.

According to any of the examples disclosed herein, the method can comprise using the mobile platform to move the arm along an entirety of the length of the waste collection container.

According to any of the examples disclosed herein, the method can comprise attaching the waste collection container to the transport truck.

According to any of the examples disclosed herein, the method can comprise fixedly and/or pivotably attaching the arm to a transport truck, so that the arm cannot move in a translatory manner relative to the transport truck.

According to any of the examples of the methods disclosed herein, the arm is attached to a frame of the transport truck, at a position that is between the waste collection container and a passenger cabin of the transport truck.

According to any of the examples of the methods disclosed herein, the arm is attached directly to the frame of the transport truck.

According to any of the examples disclosed herein, the method can comprise attaching the arm to a transport truck; and selectively using the combined roller/loader tool as: the roller compactor to break apart, shred, and/or compact a bulky waste material in a waste collection container; and the waste loader to move the bulky waste material into the waste collection container and/or remove the bulky waste material from the waste collection container.

According to any of the examples of the methods disclosed herein, the arm is fixedly and/or pivotably attached to the transport truck, so that the arm cannot move in a translatory manner relative to the transport truck.

According to any of the examples of the methods disclosed herein, the arm is attached to a frame of the transport truck.

According to any of the examples of the methods disclosed herein, the arm is attached directly to the frame of the transport truck.

### BRIEF DESCRIPTION OF THE DRAWINGS

By way of example, specific examples of the disclosed device will now be described, with reference to the accompanying drawings.

FIG. 1 is a top view of an example embodiment of a mobile waste system comprising a single arm with a combined roller/loader attached at an end thereof.

FIGS. 2 and 3 are side views of the mobile waste system of FIG. 1, with the roller/loader in different positions.

FIGS. 4 and 5 are perspective view of the mobile waste system of FIGS. 1-3.

FIGS. 6-9 show various views of the roller/loader of the mobile waste system of FIGS. 1-5, the roller/loader being in a roller (i.e., closed) configuration.

FIGS. 10-13 show various views of the roller/loader of FIGS. 6-9 in a partially opened configuration.

FIGS. 14-17 show various views of the roller/loader of FIGS. 6-13 in a loader (i.e., open) configuration.

FIG. 18 is a side view of the mobile waste system of FIGS. 1-5, in which the roller/loader is being used to grasp and lift a dumpster or scoop.

FIGS. 19-21 show various views of another example embodiment of a combined roller/loader that can be used in the system shown in FIG. 1.

The drawings are not necessarily to scale. The drawings are merely representations, not intended to portray specific parameters of the disclosure. The drawings are intended to depict various examples of the disclosure, and therefore are not considered as limiting in scope. In the drawings, like numbering represents like elements.

### DETAILED DESCRIPTION

Grapples and roller compactors are both used to serve the waste removal industry. However, grapples and roller compactors are conventionally separate tools that are attached to separate trucks or vehicles. A combined roller/loader is disclosed in the presently disclosed subject matter, in which a single implement or tool can be used to both load the waste material into a waste collection container and also compact the waste material after it has been loaded into the waste collection container. The roller/loader disclosed herein can be mounted onto an articulating arm. This articulating arm can be, for example, attached to a vehicle (e.g., a transport truck) used to pick and haul waste to a waste facility. In some instances, the roller/loader disclosed herein can be attached, for example, to an excavator, to a waste loader, or a crane (e.g., at a waste facility). In some instances, the articulating arm can be statically positioned, meaning it is not attached to a mobile vehicle.

Various example embodiments of mobile waste systems are disclosed herein for the efficient transport and disposal of waste material and, particularly, bulky waste material. The terms “mobile waste system, “mobile waste system,” and “waste transport/compaction system” can be used interchangeably herein. The example waste systems disclosed herein are advantageously used for compacting and/or hauling bulky waste materials, meaning waste materials that naturally have a large amount (e.g., as a percentage) of air, or voids, of a total volumetric region occupied by the waste material in an uncompacted state. As the term is used herein, “bulky waste material” generally refers to waste types that are too large to be picked up and transported by traditional garbage collection methods. Thus, these bulky waste materials are materials that are capable of undergoing a high level of compaction, yet occupy a large volume unless and until compacted. Non-limiting examples of bulky waste material includes construction materials (e.g., lumber, boxes, pipes, carpet, stone, concrete, plywood, and plywood sheets), shipping materials (e.g., pallets, crates, and/or portions thereof), furniture (e.g., couches, cabinets, chairs, and desks), appliances (e.g., refrigerators, washing machines, clothes dryers, dishwashers, and ovens), plumbing fixtures (e.g., sinks, toilets, tubs, and shower enclosures), vegetation (e.g., branches, brush material, and logs), and the like. The most commonly used method of collecting bulky waste material at present is through the use of grapple trucks, which are generally incapable of compacting the bulky waste material to a significant degree (e.g., by at least 25% by volume).

The waste systems disclosed herein are more efficient that currently known systems and methods for transporting and disposing of waste materials, as the disclosed waste systems enable a larger mass of the waste material to fit into any desired waste collection container, which can be of any suitable size. Thus, by using the disclosed waste systems, it is possible to load, transport, and dispose of a mass of waste material that is greater than what is possible using known systems and devices, allowing a single truck to transport a mass of waste material that would require two or more trucks to transport using conventionally known technology.

A further advantage provided with the mobile waste systems disclosed herein is that waste material may be collected from multiple different locations without requiring the transport of the waste collection containers from each of these different locations. Thus, the mobile waste systems disclosed herein can receive bulky waste material into the waste collection container at a first location, compact the bulky waste material, move to a second location, receive additional bulky waste material into the waste collection container at the second location, compact the newly added bulky waste material, and proceed to another location, repeating the steps of receiving bulky waste material into the waste collection container, compacting the bulky waste material within the waste collection container, and moving to another location until the waste collection container is full and cannot be loaded with any more bulky waste material without first being emptied (e.g., at a disposal or collection site). The bulky waste materials from different locations can be the same as or different from each other.

Thus, the mobile waste systems disclosed herein are operable at higher efficiencies compared to known systems and allow for reduced operating and capital costs because the mobile waste systems disclosed herein can compact the waste material such that the density of the waste material within the waste collection container is greater than the density of the waste material within the container at the waste generating site from which the waste material was received within the waste collection container. As an illustrative example for the increased efficiency provided by the disclosed mobile waste systems, the waste collection container can have a volume of 45 cubic yards. The waste compactor of the mobile waste system can be used to compact the bulky waste material (e.g., pallets) received within the waste collection container from a 30 cubic yard open-top dumpster by 50% (e.g., such that the compacted waste material in the waste collection container occupies 50% of the volume of the uncompacted bulky waste material when in the waste collection container). Thus, such example mobile waste systems disclosed herein are capable of transporting a mass of waste material equivalent to what would require three (3) trucks and open-top containers known from the prior art.

A further advantage is provided by using the mobile waste systems disclosed herein, in which compaction and removal of the waste material is performed in a single trip, rather than requiring multiple trips by multiple vehicles as is currently required using known technology. A further advantage provided is that mobile waste systems disclosed herein are able to provide greater compaction than currently known compactors. The reason for this is that it is not economical for such currently known compactors to revisit the waste material generating site to compact any additional waste material added to the dumpster before the waste material is removed (e.g., by being transported on a truck) from the waste material generating site, thereby leaving at least some portion of the waste material uncompacted, which causes the dumpster to not be filled with as great a mass of the waste material as would be possible if the waste material were compacted immediately before removal from the waste material generating site.

Further, even if a conventional compactor were to repeatedly be sent to the same waste material generating site to compact waste material within a dumpster, the uncompacted portion of the waste material within the dumpster would diminish. By way of example, assuming the dumpster were full and a conventional compactor were used to compact the volume by 50%, then the 50% of the dumpster volume available were filled again with uncompacted waste material, and a conventional dumpster were used again to compact the uncompacted waste material by 50% volume, leaving 25% of the dumpster volume empty. This would continue until the dumpster is substantially full, but the intervals between when the compactor would need to be used would be increasingly shortened after each compaction, which is not commercially feasible. Due to the diminishing efficacy of performing multiple compactions, using known systems and methods results in even a “full” dumpster being almost certain to contain a significant portion (e.g., greater than 10%, greater than 25%, or greater than 50%) by volume of the contents thereof that are uncompacted, since there are no known systems that both compact and remove bulky waste material from a waste material generating site in a single trip, much less transfer compacted waste material into a waste collection container on the truck so that it is possible for the mobile waste systems disclosed herein to contain entirely (e.g., 100% by volume) compacted waste material. Rather, the presently disclosed mobile waste systems and methods load and compact waste material during the same visit to a waste material generating site, enabling all of the waste material that is removed and transported from the waste material generating site to be compacted. Additionally, since the presently disclosed mobile waste systems and methods are capable of loading and compacting the waste material in increments (e.g., by compacting the waste material when only a portion of a waste container's waste material has been received in the waste collection container), the presently disclosed mobile waste systems and methods provide improved levels of compaction than conventional standalone mobile compactors, which compact containers that are full (e.g., at least 95% full by volume) or substantially full (e.g., at least 90% or at least 80% full by volume), such that a significant amount (e.g., up to 50% by volume) of the waste material that is removed by the conventional waste material removal and transport systems is not compacted, since repeat compacting trips by a conventional compactor offer diminishing returns, both practically and economically as noted elsewhere herein for conventional waste systems, due to the fact that each subsequent trip would only compact an ever-decreasing portion of the container, unlike in the presently disclosed mobile waste systems and methods, in which the waste material is loaded into the waste collection container and compacted in increments (e.g., by only loading a first portion of waste material from a waste container into the waste collection container, compacting this first portion of the waste material, loading a second portion of waste material from the waste container into the waste collection container, compacting this second portion of the waste material, and repeating until either the waste collection container is full or substantially full with compacted waste material or all of the waste material has been loaded into the waste collection container).

In some embodiments, the presently disclosed mobile waste systems and methods are advantageous in that conventionally used large open-top dumpsters can be replaced at waste material generating sites with less expensive containers, smaller containers, or even with no containers for some types of bulky waste material. Conventional open-top dumpsters are expensive, in part, because they must be rigid and sufficiently durable to withstand years of being pulled on and off the roll-off trucks, as well as being safe while transporting waste material therein. While the presently disclosed mobile waste systems and methods are configured to transfer waste material from such conventional open-top dumpsters into the waste collection containers disclosed herein, the use of such conventional open-top dumpsters is not required and, in fact, the waste collection containers disclosed herein are configured to receive waste material from any suitable source (e.g., including a pile of waste material on the ground). This ability to utilize different or no waste containers is advantageous, in that it provides increased operational flexibility and cost-savings for customers, who may opt to use an area, their own waste containers, smaller waste containers, less rigid waste containers (e.g., flexible bags made of a suitably durable material for the waste material being contained therein), or no waste containers. For example, the waste collection containers disclosed herein can be used in place of a conventional roll-off style dumpster for the collection and containment of waste material and can, in fact, be operated to compact the waste material periodically or upon receipt of a command to do so, such as when a level of waste material within the waste collection container has been detected as being above a top surface of the waste collection container. In some situations, the mobile waste systems disclosed herein can be provided with waste collection containers that have a smaller volume than would be necessary for a conventional dumpster, since such mobile waste systems can compact the waste material as and/or after the waste material is received within the waste collection container, thereby negating the need for use of a large, conventional open-top dumpster to contain the uncompacted volume of the waste material. The use of smaller waste collection containers in the presently disclosed mobile waste systems than is required for known systems that use a conventional dumpster is more economical.

A further benefit provided by the presently disclosed mobile waste systems and methods is the ability to receive, when mounted onto the back of a transport truck, for example, waste material from multiple waste containers at a waste material generating site, unlike conventional waste material removal and transport systems, in which only a single waste container (e.g., conventional dumpster) can be transported at a time on one transport truck, regardless of the size or volume of the waste container. For example, the presently disclosed mobile waste systems and methods are more economical and versatile than known systems because the presently disclosed mobile waste systems can receive and compact bulky waste material from multiple waste containers at a waste material generating site, whereas conventional systems using conventional roll-off dumpsters and conventional roll-off transport trucks can only transport one waste container at a time.

The mobile waste systems and methods disclosed herein are more economical and versatile than conventionally known shredders, grinders, and/or chippers for mobile removal of bulky waste. The presently disclosed mobile waste systems and methods can compact virtually any type of waste material, whereas conventional shredders, grinders, and chippers are either limited to process only specific types of waste materials in order to prevent jamming of the machine, or are so massive and expensive as to be impractical for use in a mobile application. Additionally, the presently disclosed mobile waste systems and methods both compact and also shred the waste material, unlike some conventional shredders that output a waste product that is fluffy and unsuitable for compaction.

While example embodiments of mobile waste systems and methods are shown herein, the mobile waste systems and methods disclosed herein can be embodied in any suitable configuration(s) and with any combination(s) of components disclosed in here, including combinations of components from different embodiments that are not expressly disclosed herein as being suitable for being combined. In some embodiments, the vehicle of the example mobile waste systems disclosed herein is a so-called dump truck, which has a waste collection container that is attached to the frame, or chassis, of the truck and is pivotable about an axis of rotation, typically defined at the rear edge of the container (e.g., relative to the edge nearest the cabin of the dump truck), such that compacted waste material can be removed from the waste collection container by pivoting the waste collection container about the axis of rotation and opening a door or gate formed as all or a portion of the rear wall of the waste collection container, such that the compacted waste material slides (e.g., due to gravity) out of the waste collection container. In some such embodiments, the roller/loader is mounted to the waste collection container itself. In such embodiments, the roller/loader can advantageously be powered via permanent connections to the power take-off (PTO) and electrical system of the dump truck.

The presently disclosed mobile waste systems and methods are also more economical and more versatile than conventional on-site compactors, even in instances in which such conventional compactors were to be attached to waste containers, since such conventional compactors are known to be both expensive and also limited in terms of the types of waste materials that can be compacted therein, as noted elsewhere herein.

In some embodiments, the mobile waste systems disclosed herein are configured to remove waste material from a region or container that is not a substantially rigid conventional dumpster, whether roll-off style or otherwise, including a container with flexible sidewalls. In some embodiments, this region is a space delimited by, for example and without limitation, concrete blocks. At waste generating sites such as manufacturing and distribution facilities where dumpsters permanently reside at present, the use of such mobile waste systems as are described herein would allow for, in some instances, such dumpsters to be replaced by a physically confined area, such as may be formed by walls of concrete blocks, fencing, and the like. Furthermore, at temporary locations where waste material is generated (e.g., at construction sites), the mobile waste systems disclosed herein would allow for the waste material to be held, for example, in areas delimited by inexpensive plywood sheets or semi-flexible bag-style “dumpsters” instead of in conventional dumpsters. The mobile waste systems would thus be capable of removing the waste material intermittently (e.g., on a prescribed schedule, such as weekly) as the waste material is generated but would also allow for the collection of the temporary structures (e.g., plywood sheets or semi-flexible bag-style “dumpsters”) after the waste-generating activity has been completed, thereby rendering it unnecessary for a dumpster servicing company to retrieve a conventional dumpster, as is currently necessary.

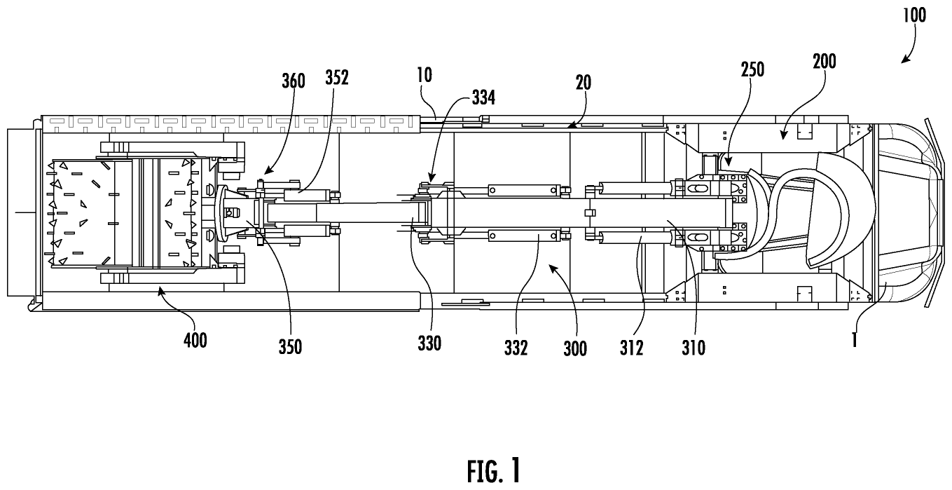

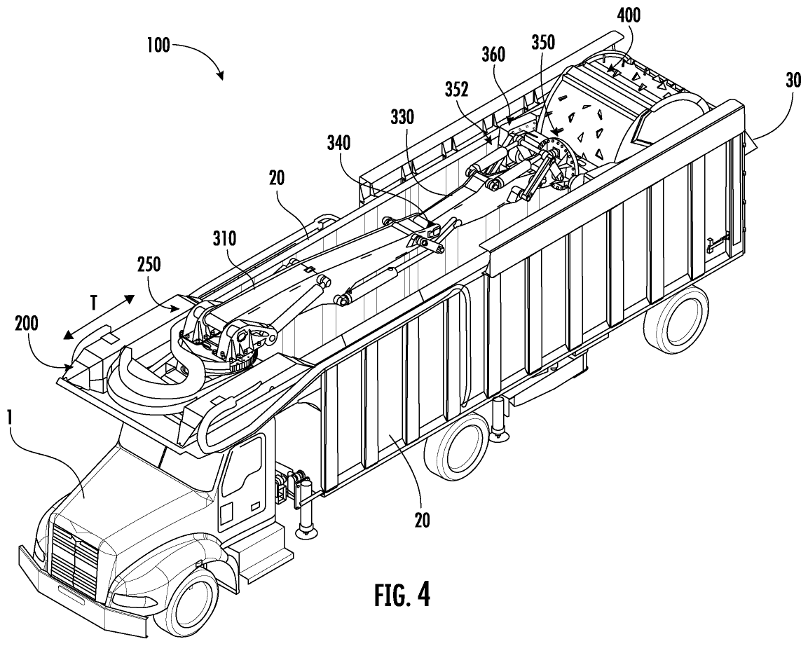

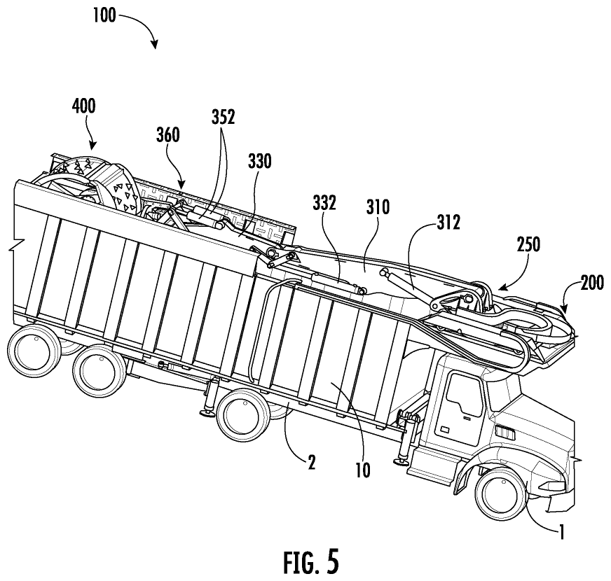

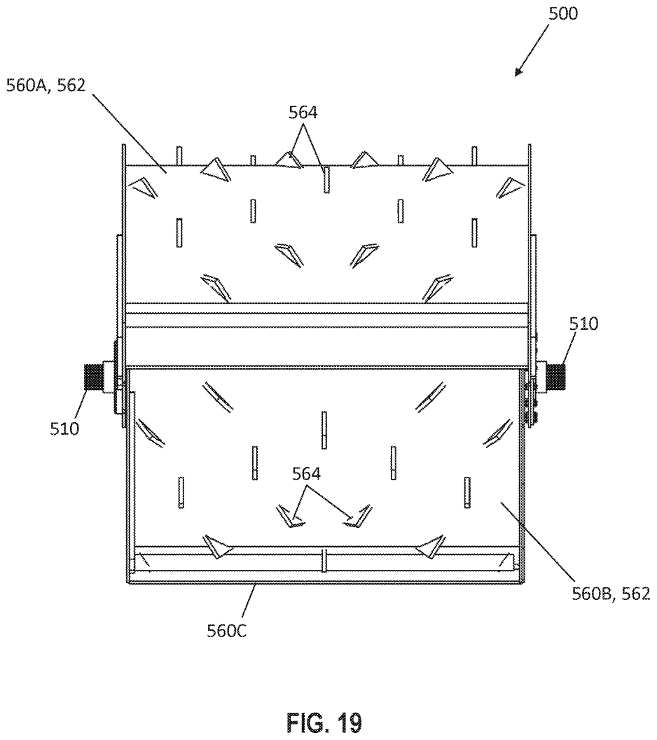

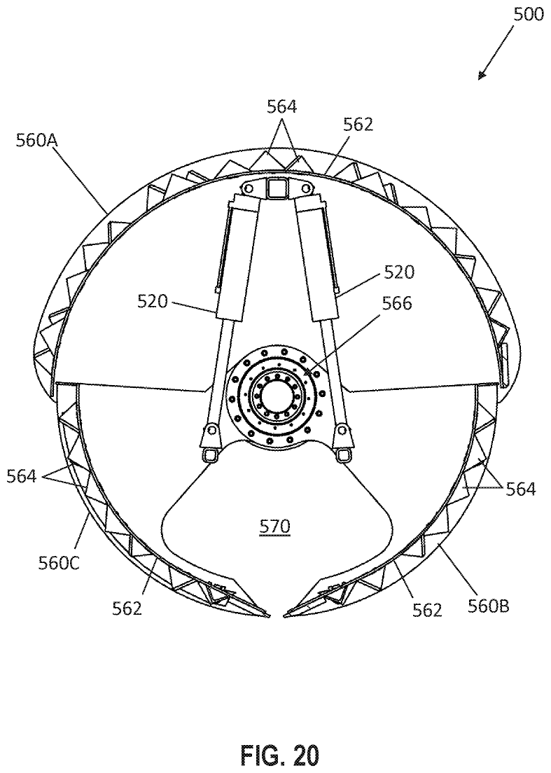

FIGS. 1-5 show various features of an example embodiment of a mobile waste system, generally designated 100, according to the subject matter disclosed herein. The mobile waste system 100 comprises a waste collection container 10 (e.g., an open-top dumpster), an arm, generally designated 300, a roller/loader, generally designated 400, attached to the end of the arm 300, and a mobile platform, generally designated 200, which connects the arm 300 to the waste collection container 10. The roller/loader 500, shown in FIGS. 19 and 20, can be used in the mobile waste system 100 in place of the roller/loader 400. The term “loader” is used herein in a generic sense and can encompass any mechanism that can be used to manipulate, lift, deposit, etc. bulky waste material; the term “loader” can be and is used interchangeably with the term “grapple” herein. In this example, the waste collection container 10 is shown being attached to an optional transport truck 1. Thus, the mobile waste system 100 is usable with a stand-alone waste collection container 10 or a transport truck 1 attached to the waste collection container 10. In some embodiments, the waste collection container 10 can be pivotably attached to the transport truck 1.

In the example embodiment shown in FIGS. 1-5, the waste collection container 10 is fixedly (i.e., non-pivotably) attached to the transport truck 1. In some embodiments of the mobile waste system 100, the waste collection container 10 is detachable from the transport truck 1 in a sliding manner, as in the case of a conventional roll-off truck and dumpster. In instances in which the waste collection container 10 is separable from the transport truck 1, the mobile waste system 100 can comprise a quick disconnect for connecting and disconnecting in a toolless manner the waste collection container 10 to hydraulic, electric, and/or pneumatic sources of the transport truck 1.

The terms “truck” and “vehicle” can be used interchangeably and generally refer to a mobile conveyance capable of operating in the manner described herein. In embodiments in which the mobile waste system 100 does not include the optional transport truck 1, the mobile waste system 100 is capable of operating as a direct replacement for a conventional dumpster. In embodiments in which the mobile waste system 100 does not include the optional transport truck 1, the waste collection container 10 is advantageously attached to the transport truck 1 during transport of the waste collection container 10 to and/or from a waste disposal and/or collection site.

The arm 300 comprises a boom arm 310, a stick arm 330, and a connector 350. The boom arm 310 is attached to the waste collection container 10 by a mobile platform, generally designated 200. The platform 200 is movable in the direction T along the longitudinal axis of the waste collection container 10. The platform 200 engages with a track 20 provided at the upper edge of the waste collection container 10. The platform 200 can have round wheel gears with teeth around the perimeter thereof that engage with teeth formed along the length of the track 20. Thus, by turning the wheel gears of the platform 200, the platform 200 can move in the direction T along and relative to the track 20. The waste collection container 10 comprises a storage position, which is where the arm 300 is positioned when not in use (e.g., while the transport truck 1 is in motion). The storage position is a shallow region of the waste collection container 10 and a majority (e.g., substantially all of, such as over 90%) of the volume of the waste collection container defined by the storage position is positioned over the passenger cabin of the transport truck 1.

The boom arm 310 is attached to the platform 200 by a mount 250 that allows the boom arm 310 to pivot in a vertically-extending plane and swivel in a horizontally-extending plane, both pivoting and swiveling movements being relative to the platform 200. The boom arm 310 may pivot and/or swivel while the platform 200 is moving in the direction T along the track 20. The pivoting movement of the boom arm 310 relative to the mount 250 is controlled by one or more boom actuators 312. The stick arm 330 is pivotably and/or swivelably attached to the boom arm 310 at a distal end of the boom arm 310, opposite the proximal end of the boom arm 310 where the boom arm 310 is attached to the mount 250. One or more stick actuators 332 extend between the boom arm 310 and the stick arm 330 for controlling, by an extension or retraction of the stick actuators 332, a pivoting movement of the stick arm 330 about the distal end of the boom arm 310. Extension of the stick actuators 332 is translated into relative movement of the boom arm 310 and the stick arm 330 by the linkage arms 342, 344, to which the stick actuator 332 is attached (e.g., directly). The linkage arm 342 is attached to the distal end of the stick actuator 332 and the boom arm 310. The linkage arm 344 is attached to the distal end of the stick actuator 332 and the stick arm 330.

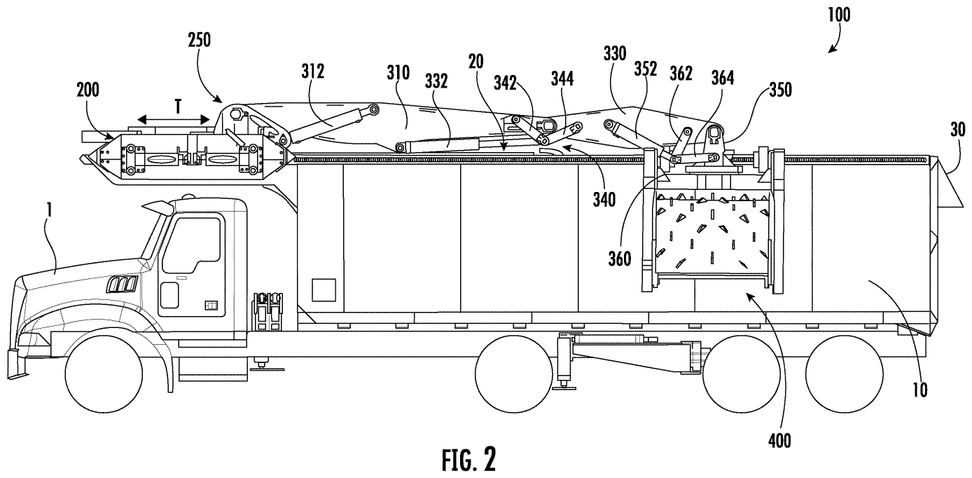

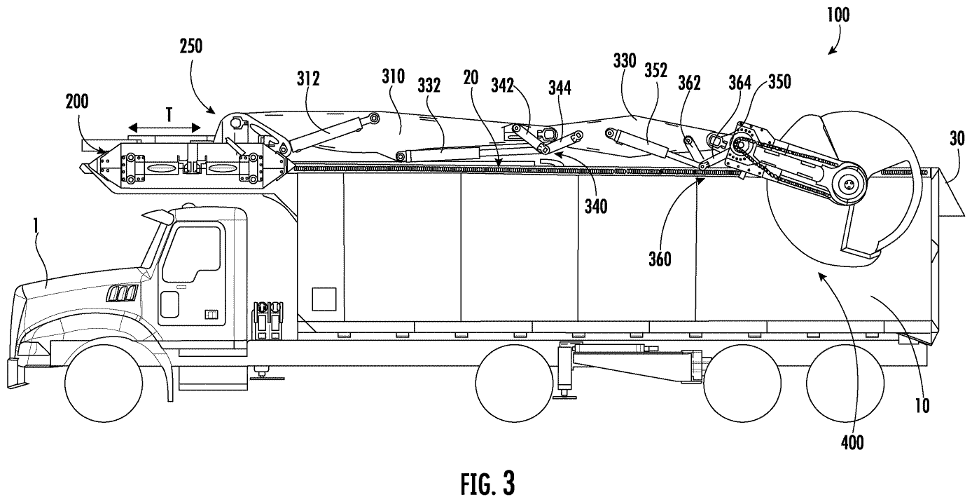

The connector 350 is attached, at a distal end of the stick arm 330, to the stick arm 330. The connector 350 is mobile relative to the stick arm 330. For example, the connector 350 may pivot (e.g., rotate in the plane shown in FIGS. 2 and 3) about the distal end of the stick arm 330, swivel (e.g., rotate in the plane shown in FIG. 1) about the distal end of the stick arm 330, and/or rotate with respect to (e.g., about) the longitudinal axis of the stick arm 330. In some embodiments, the connector 350 can move linearly in one or more directions that are perpendicular to the longitudinal axis of the stick arm 330. Thus, in some embodiments, the connector 350 may have up to 5 degrees-of-freedom for movement with respect to the stick arm 330. The boom and stick actuators 312, 332 can be, for example, hydraulic cylinders, pneumatic cylinders, electric motors, hydraulic motors, linear actuators, rotary actuators, and the like.

The boom arm 310 and the stick arm 330 are articulated, through extension/retraction of the boom actuator 312 and the stick actuator 312, respectively, such that the connector 350 can extend, or reach, into a dumpster adjacent to the rear of the waste collection container 10 and also within the waste collection container 10 itself. The connector 350 is actuated (e.g., rotated, swiveled, pivoted, and/or moved) with one or more boom actuators 352. Examples of such actuators 352 can include, for example and without limitation, hydraulic cylinders, pneumatic cylinders, linear actuators, rotary actuators, hydraulic, motors, electric motors, and the like. Extension of the boom actuators 352 is translated into relative movement of the stick arm 330 and the connector 350 by the linkage arms 362, 364, to which the boom actuator 352 is attached (e.g., directly). The linkage arm 362 is attached to the distal end of the boom actuator 352 and the stick arm 330. The linkage arm 364 is attached to the distal end of the boom actuator 352 and the connector 350.

In some embodiments, the connector 350 and/or the stick arm 330 may be provided with a locking mechanism, by which the pivoting, swiveling, rotating, and/or translating movement of the connector 350 with respect to the stick arm 330 may be prevented or resisted, such that the connector 350 cannot move relative to the stick arm 330. This positional locking of the connector 350 with respect to the stick arm 330 can advantageously be used while, for example, using the roller/loader 400 to forcibly grasp or agitate the waste material and/or to break apart the waste material within the waste collection container 10.

The arm 300 is not in any way limited to having only a boom arm 310 and a stick arm 330. Instead, the arm 300 can have any suitable construction, quantity, and type of arms, arm segments, sections, and the like. A nonlimiting example of such arms or arm segments includes one or more telescoping arms or telescoping arm segments. These arms, arm segments, sections, etc. of the arm 300 can move in relation to each other in any suitable manner based on the design of the waste loader 300. Thus, in some embodiments, the connection or joint between arm segments or sections can have up to 6 degrees of freedom.

Together, the relative movements of the stick arm 330 and boom arm 310, with respect to each other and/or to the mount 250, enable the arm 300 to be used for positioning the connector 350 horizontally and vertically above and within both the dumpster and the waste collection container 10.

In the example embodiment of the mobile waste system 100 shown in FIGS. 1-5, the rear surface of the waste collection container 10 disclosed herein is formed as an inclined ramp 30 so that any such waste material that might otherwise fall between the space between the rear of the waste collection container 10 and the front of the dumpster will land on this inclined ramp 30 and thus slide back into the dumpster. The angle of inclination of the inclined ramp 30 is advantageously sufficient such that the lower edge of the ramp 30 creates a space that allows for safe operation of the transport truck 1 in being sufficiently near to the dumpster for the roller/loader 400 to operate in removing the waste material from the dumpster, but maintaining a margin of safety that minimizes the risk of the waste collection container 10 or the transport truck 1 striking the dumpster while the transport truck 1 is backing up to be adjacent to the dumpster. For example, the lower edge of the inclined ramp 30 may extend away from the rear surface of the waste collection container 10 by about 6 inches, about 1 foot, about 2 feet, etc.

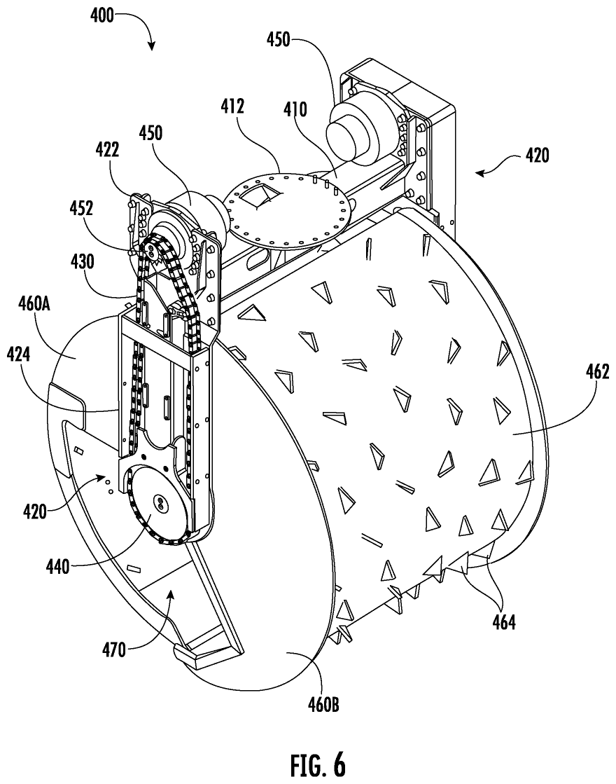

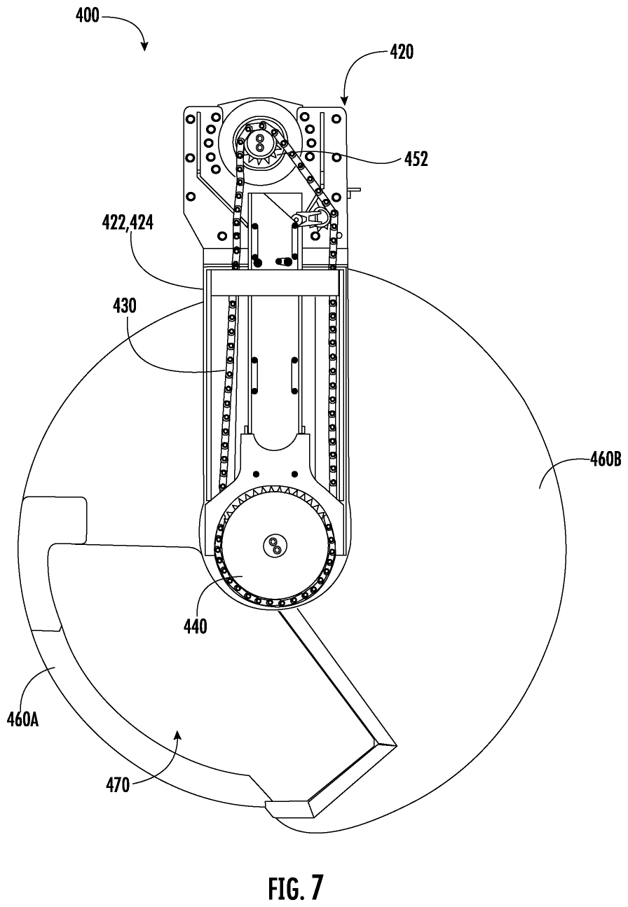

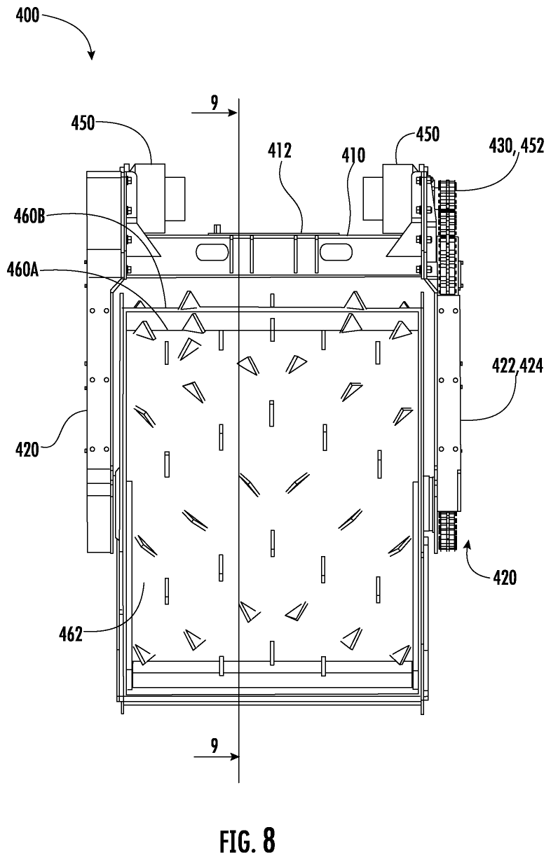

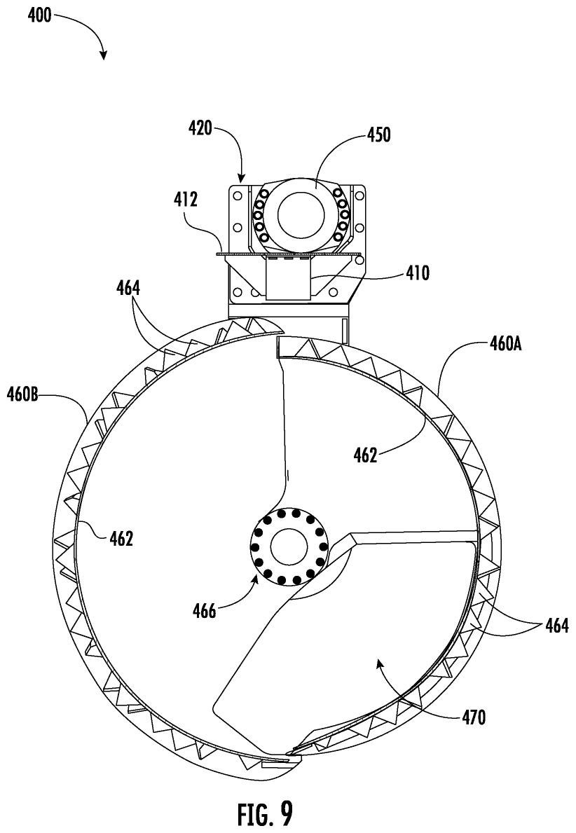

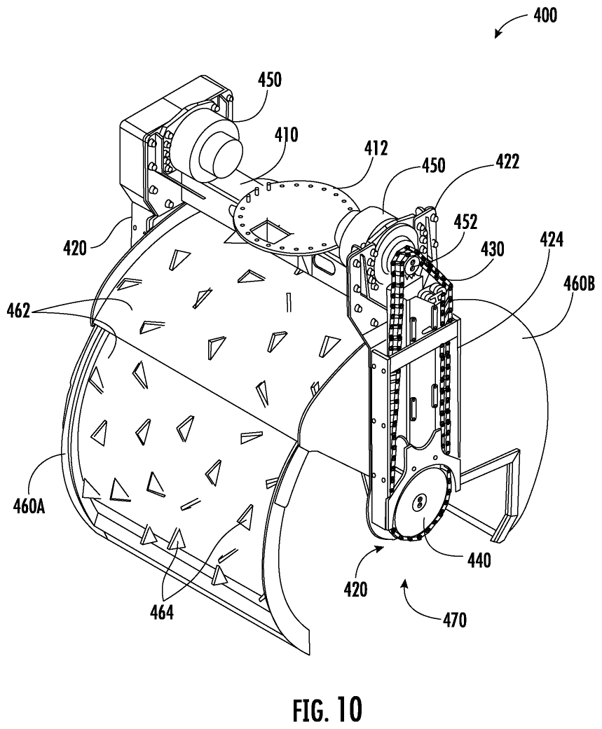

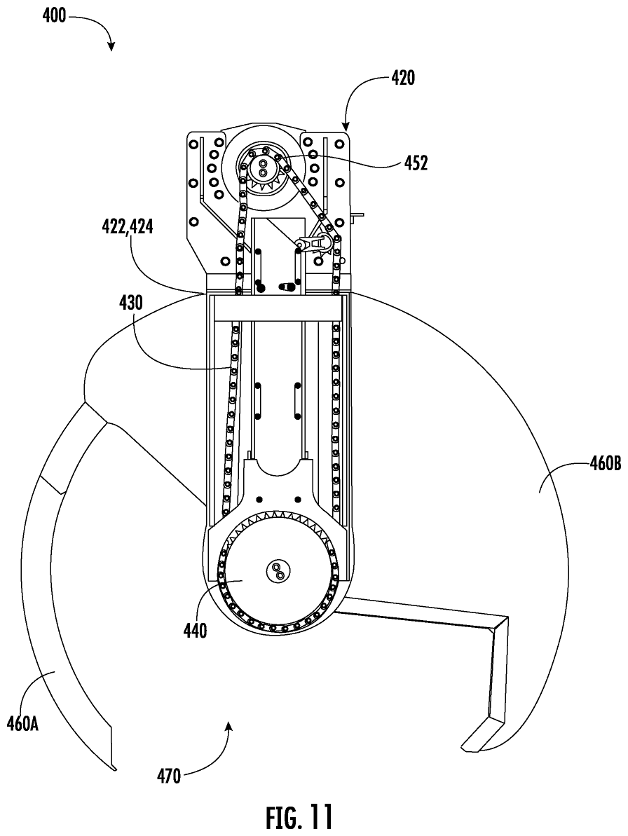

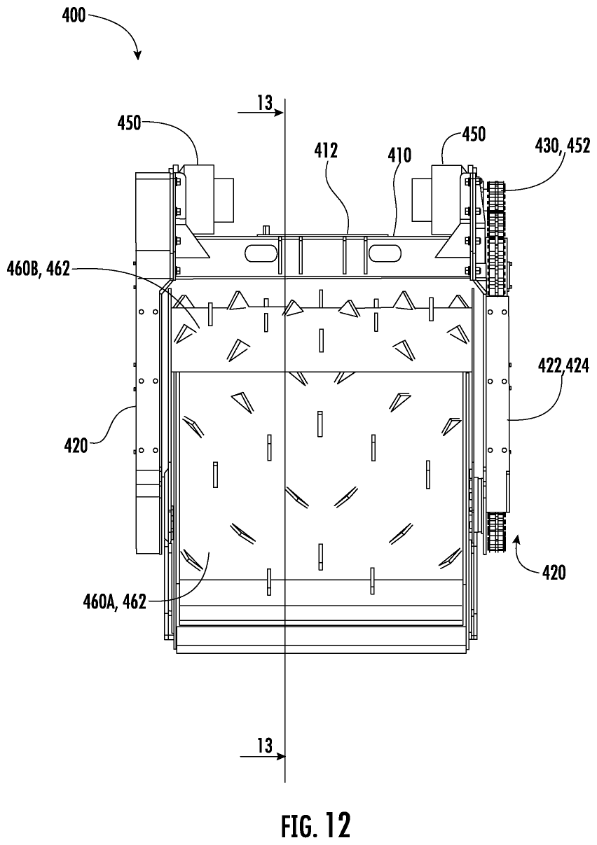

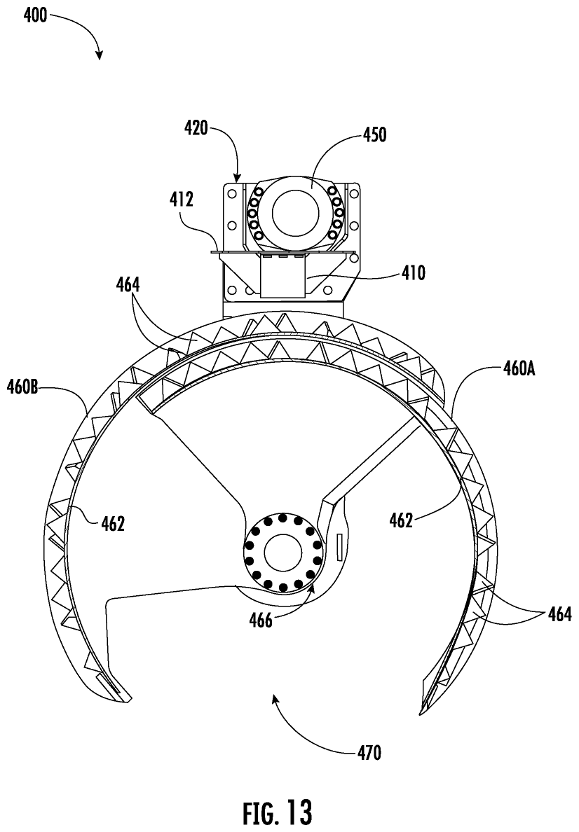

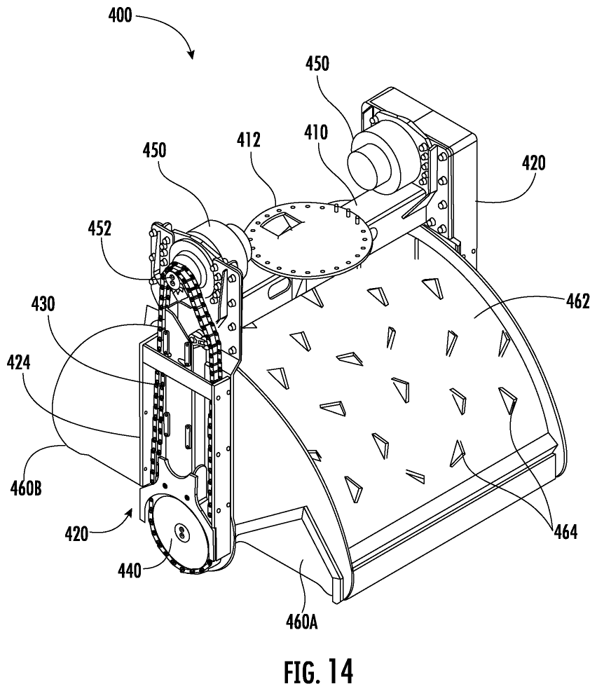

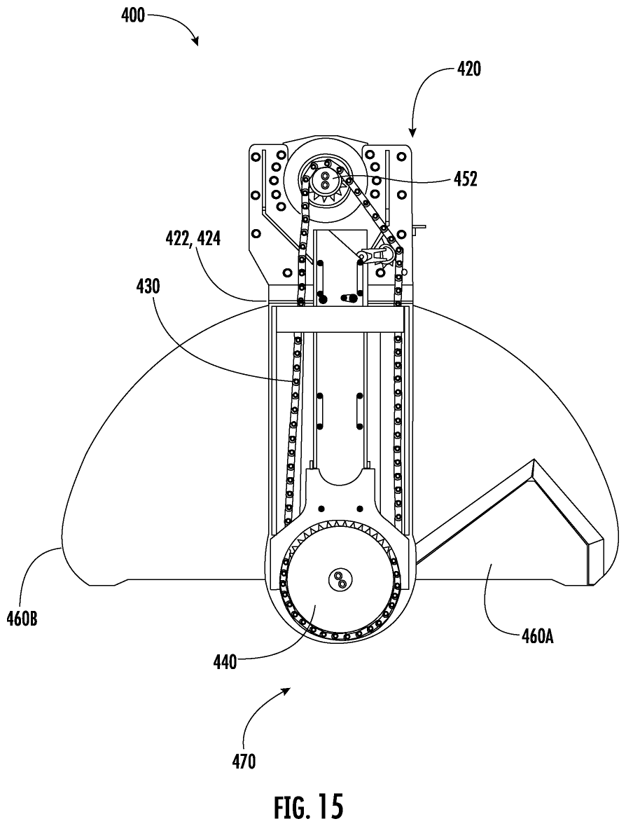

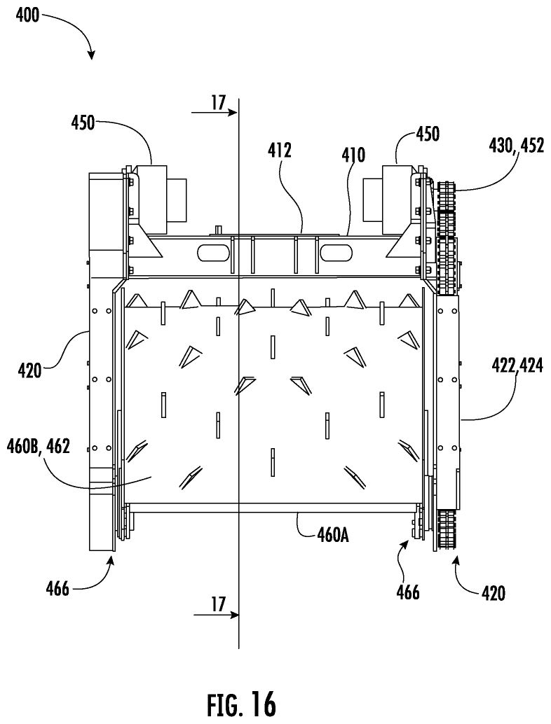

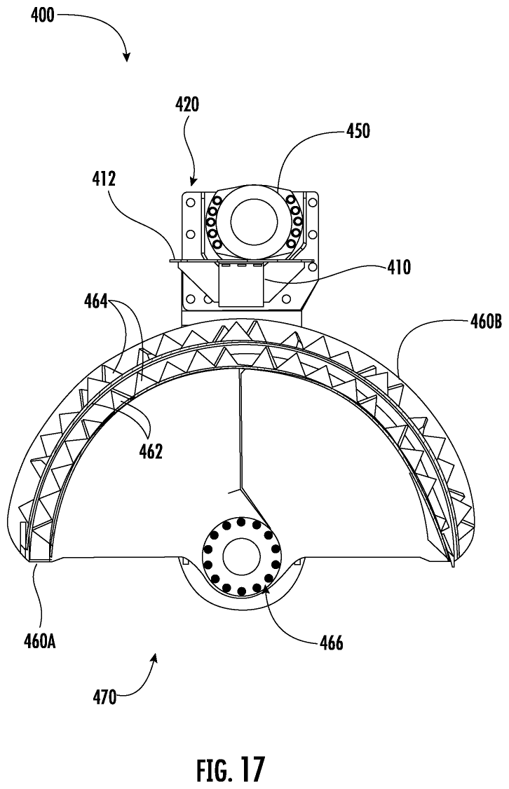

Aspects of the example first embodiment of the roller/loader 400 will be discussed herein in relation to FIGS. 6-17. The roller/loader 400 comprises a substantially U-or C-shaped rigid frame. The frame rotatably supports two hemicylindrical parts 460A, 460B that form the portion of the roller/loader 400 that is configured to manipulate (e.g., grasp) and compact (e.g., by shredding or otherwise breaking apart) the waste material. FIGS. 6-9 show the hemicylindrical parts 460A, 460B in a roller, or closed, configuration. FIGS. 10-13 show the hemicylindrical parts 460A, 460B in a partially open configuration. FIGS. 14-17 show the hemicylindrical parts 460A, 460B in a loader, or open, configuration. The hemicylindrical parts 460A, 460B can be formed using any suitable manufacturing technique, including, for example and without limitation, casting, machining, additive manufacturing, forging, welding, and the like.

The frame of the roller/loader 400 comprises an upper bar 410, which extends substantially parallel to the axis of rotation of the hemicylindrical parts 460A, 460B, and two arms, generally designated 420, that extend substantially perpendicularly to the direction of extension of the upper bar 410. The upper bar 410 has a mounting plate 412 attached thereto, the mounting plate 412 being configured to rigidly (e.g., immovably) attach the roller/loader 400 to the connector 350. The arms 420 have a base plate 422 and a motor 450 attached to a first end of the base plate 422 of the arm 420, the motor 450 being fixedly attached to a driving sprocket 452 to co-rotate together. The arms 420 also have a driven sprocket 440 that is attached to a second end of the base plate 422 of the arm 420. The driven sprocket 440 of one arm 420 is attached to (e.g., rigidly, so as to co-rotate with) one of the hemicylindrical parts 460A, 460B and the driven sprocket 440 of the opposing arm 420 is attached to (e.g., rigidly, so as to co-rotate with) the other one of the hemicylindrical parts 460A, 460B. Each arm 420 comprises a chain 430 that is configured to engage with teeth of the driving sprocket 452 and the driven sprocket 440, transmitting a rotary force from the driving sprocket 452 to the driven sprocket 440 and, accordingly, from the motor 450 to one of the hemicylindrical parts 460A, 460B. Thus, one motor 450 controls movement of the hemicylindrical part 460A and the other motor 450 controls movement of the hemicylindrical part 460B and, as such, the hemicylindrical parts 460A, 460B are controlled and rotated independently of each other. The arms 420 each comprise chain guides 424 that protect the chain 430 form being struck by debris. By mounting the motors 450 external to (e.g., above) the hemicylindrical parts 460A, 460B, rather than axially inside the hemicylindrical parts 460A, 460B, a hollow drum-shaped volume is formed within the hemicylindrical parts 460A, 460B, thereby maximizing the volume of waste that the roller/loader 400 can pick up. In some examples, the motors 450 can be mounted axially within the hemispherical parts 460A, 460B; such an arrangement can be advantageous to, for example, protect the motors from being struck during use while protruding axially from the roller/loader 400. Regardless of their placement, the motors 450 can be driven electrically, hydraulically, pneumatically, or using any other suitable power source. In some embodiments, the motors 450 can be connected to the hemicylindrical parts 460A, 460B by, for example, a gear train, a tensioned belt, and the like.

The hemicylindrical parts 460A, 460B each have an outer circumferential surface 462 that extends at least about 180°about the axis of rotation. The hemicylindrical parts 460A, 460B each have agitators 464 attached over the surface of the circumferential surface 462. The agitators 464 are shaped to compact and shred virtually any type of bulky waste material into smaller pieces that are more readily compressible with smaller total void area (e.g., having a greater density) within the waste collection container 10. The agitators 464 can have any suitable shape and dimensions based on the waste material to be broken apart and/or compacted by the roller/loader 400. The agitators 464 can be attached (e.g., by welding, or during additive manufacturing of the hemicylindrical parts 460A, 460B) to the outer surface of the hemicylindrical parts 460A, 460B in any suitable quantity and arrangement. In some embodiments, the agitators 464 can be formed in a unitary manner with the circumferential surface 462 of the hemicylindrical parts 460A, 460B. In some embodiments, the agitators 464 can be omitted from the surface of the hemicylindrical parts 460A, 460B. In some such embodiments, the agitators 464 can be replaced with a textured (i.e., unevenly shaped, such as in the manner of a series of pyramidally-shaped protrusions) surface over the circumferential surface 462.

The hemicylindrical parts 460A, 460B have cavities formed in the sidewalls thereof that define a recess, generally designated 470. The hemicylindrical parts 460A, 460B are attached to the respective driven sprockets 440 by a respective inner plate, generally designated 466. Thus, the inner volume of the hemicylindrical parts 460A, 460B is substantially empty (e.g., at least 90% by volume) and there is no axle or other longitudinal member passing through the hemicylindrical parts 460A, 460B, between the driven sprockets 440 of the arms 420, at least not beyond the inner plates 466. The hemicylindrical parts 460A, 460B rotate about an axis of rotation defined through the driven sprockets 440 on the opposing arms 420. The hemicylindrical parts 460A, 460B can rotate in either direction about the axis of rotation. The hemicylindrical parts 460A, 460B rotate between the closed position shown in FIGS. 6-9 and the open position shown in FIG. 14-17. For the roller/loader 400 to be used as a roller compactor, the hemicylindrical parts 460A, 460B are in the closed position shown in FIGS. 6-9. For the roller/loader 400 to be used as a waste loader, the hemicylindrical parts 460A, 460B are moved away from the closed position, forming a void between the open ends of the hemicylindrical parts 460A, 460B, so that the hemicylindrical parts 460A, 460B can be engaged around the waste material and the hemicylindrical parts 460A, 460B can be rotated towards the closed position to grasp the waste material both within the volume defined by the hemicylindrical parts 460A, 460B and also between the edges of the hemicylindrical parts 460A, 460B. The roller/loader 400 can then, once engaged with the waste material, lift the waste material into the waste collection container 10.

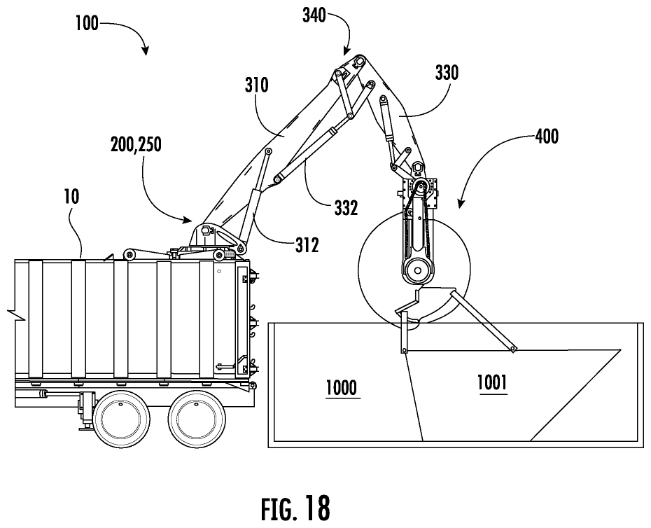

The first hemicylindrical part 460A has a smaller radius than the second hemicylindrical part 460B, such that the first hemicylindrical part 460A rotates within (e.g., to a position radially internal to) the second hemicylindrical part 460B in the open position shown in FIGS. 14-17. When in the closed position, the hemicylindrical parts 460A, 460B form a substantially cylindrically-shaped roller that can rotate in either direction so as to propel itself over the waste material for compacting the waste material. When in the open position, the hemicylindrical parts 460A, 460B act as a grapple or claw, with the hemicylindrical parts 460A, 460B opening and closing as needed to grab and dump waste material, or to pick up and dump dumpsters (e.g., 1001, FIG. 18) filled with waste material.

In some embodiments, a slew ring can be mounted between the mounting plate 412 and the connector 350 of the arm 300 to enable an axis of rotation around the center point of the upper bar 410.

The hemicylindrical parts 460A, 460B are driven independently, such that the hemicylindrical parts 460A, 460B can be rotated in opposite directions to move between or into the open and closed positions. When the hemicylindrical parts 460A, 460B are in the closed position, the hemicylindrical parts 460A, 460B can be co-rotated in the same direction and at the same speed for acting as a roller for compacting and breaking apart the waste material. In some instances, it is advantageous to the hemicylindrical parts 460A, 460B while in the open position in the same direction to act as a scoop for scooping the waste material.

Each of the hemicylindrical parts 460A, 460B has outer, radially extending rings on the outer edges thereof that extend beyond the agitators 464 to protect the dumpster or waste collection container 10 from damage by preventing the agitators 464 from touching the bottom and/or side walls of the dumpster or waste collection container 10 as the hemicylindrical parts 460A, 460B in the closed position are used to roll back and forth over waste material for compacting and breaking apart the waste material. Because the first hemicylindrical part 460A turns within the second hemicylindrical part 460B, the hemicylindrical parts 460A, 460B do not form a perfect circle in the closed position. As such, the edges at the circumferential terminal ends of the hemicylindrical parts 460A, 460B are tapered to form a substantially continuous (e.g., not stepped) transition between the different radii of the two hemicylindrical parts 460A, 460B where the hemicylindrical parts 460A, 460B meet when in the closed position. This smoothed transition between the edges of the hemicylindrical parts 460A, 460B provides for smoother rolling, while also minimizing the risk of either of the hemicylindrical parts 460A, 460B gouging the dumpster or waste collection container 10 and, further, also minimizes the risk of waste material snagging the ends of the outer, radially extending rings.

A reinforcement (e.g., a V-shaped reinforcement) is attached longitudinally to the edges of each of the hemicylindrical parts 460A, 460B at the circumferential terminal ends of the hemicylindrical parts 460A, 460B to protect these edges from bending when the roller/loader 400 is used as a waste loader to pick up heavy objects, in which case the mass of such heavy objects may be concentrated near the center span of the hemicylindrical parts 460A, 460B. Thus, the reinforcement acts to reinforce these edges of the hemicylindrical parts 460A, 460B and prevent deformation thereof.

In the example embodiment shown, the sides of each of the hemicylindrical parts 460A, 460B have different shapes cut into them so as to form a variable sized and shaped recess 470 that can pick up a multitude of materials as the hemicylindrical parts 460A, 460B are rotated towards the closed position. The first hemicylindrical part 460A has a large cut out formed in the end walls thereof, shaped like a claw. The second hemicylindrical part 460B has a small notch-like cut out formed in the end walls thereof. When the hemicylindrical parts 460A, 460B, acting like jaws, are in the open position, the larger opening facilitates grabbing large objects and bundles of long objects, such as boards, timbers, and tree brush. Closing the hemicylindrical parts 460A, 460B together creates a smaller opening which is better for picking up or scooping waste material like bottles and smaller waste that typically falls to the bottom of dumpsters. Further, the hemicylindrical parts 460A, 460B can both scoop and rotate to form a clamshell-type bucket to hold small or loose debris. In other examples, however, the sides of each of the hemicylindrical parts 460A, 460B can each have a cutout that is the same shape as each other, so as to form a recess 470 that is substantially symmetrical along a line of symmetry formed between the hemicylindrical parts 460A, 460B.

The cut-outs formed in the respective end walls of the hemicylindrical parts 460A, 460B each have an angle (e.g., a right angle or acute angle) that is corner-shaped, which enables the hemicylindrical parts 460A, 460B to be used to pick up dumpsters (e.g., 1001, FIG. 18) that are equipped with two handles. As the hemicylindrical parts 460A, 460B move towards the closed position with the handles in the recess 470, the handles nest in these corners of the respective cut outs to secure the dumpster for pick up. Further, the dumpster can be dumped simply by rotating the hemicylindrical parts 460A, 460B in the same direction (e.g., remaining in the closed position).

For transport, the hemicylindrical parts 460A, 460B can be moved into the open position to minimize the volume occupied by the roller/loader 400 within the waste collection container 10.

FIG. 18 shows the mobile waste system 100 of FIGS. 1-5, in which the roller/loader 400 is used to engage with the container 1001. The container 1001 can be lifted, by engaging handles thereof within the recess 470 of the hemicylindrical parts 460A, 460B, for transferring and then dumping waste material contained within the container 1001 into the waste collection container 10. In some embodiments, the roller/loader 400 is configured to use the container 1001 as a scoop for removing waste material from a dumpster 1000 or other suitable container into which the container 1001 can fit.

Features of another example embodiment of a roller/loader, generally designated 500, are shown in FIGS. 19 and 20. This roller/loader 500 can be used in the mobile waste systems disclosed herein in place of the roller/loader 400. The roller/loader 500 is attached to or comprises, as a part thereof, a substantially U-or C-shaped rigid frame that is substantially similar to the rigid frame of the roller/loader 400.

The roller/loader 500 is formed primarily of 3 outer, or shell parts pieces, each of which are pivotably attached to each other at a central longitudinal axis. This central longitudinal axis is defined between the opposing mounting portions 510, which extend in opposite longitudinal directions to protrude beyond the outer shell pieces, such that the outer shell pieces can be driven in rotation in unison, or simultaneously. The roller/loader 500 is attached to the rigid frame by at least the mounting portions 510. Thus, the entire roller/loader 500 is rotatable around the central longitudinal axis and the two smaller outer shell pieces are also rotatable around the central longitudinal axis relative to the larger outer shell piece.

The 3 outer shell pieces are in the form of a first part 560A, a second part 560B, and a third part 560C. In the example shown, the first part 560A has a hemicylindrical shape and the second and third parts 560B, 560C each have a shape that is a quarter cylinder. Thus, the first part 560A has an outer circumferential surface 562 that extends about 180° about the axis of rotation, while the second and this parts 560B, 560C each have an outer circumferential surface 562 that extends about 90° about the axis of rotation. In some instances, the first part 560A can extend more or less than about 180° and the second and third parts 560B, 560C can extend more of less and about 90°. However, it is advantageous for the first, second and third parts 560A, 560B, 560C to cumulatively extend a total of about 360° or more about the axis of rotation (e.g., when in the closed, or roller, position). In one example, each of the first, second, and third parts 560A, 560B, 560C can each extend about 120°about the axis of rotation. The first, second, and third parts 560A, 560B, 560C can be formed using any suitable manufacturing technique, including, for example and without limitation, casting, machining, additive manufacturing, forging, welding, and the like.

The radius of the first part 560A is different from (e.g., larger than) the radius of the second and third parts 560B, 560C, such that the second and third parts 560B, 560C can rotate to be positioned radially within the first part 560A when the roller/loader 500 is in an open position. In some examples, however, the radius of the first part 560A can be smaller than the radius of the second and third parts 560B, 560C, such that the second and third parts 560B, 560C can rotation to be positioned radially around (e.g., outside of) the first part 560A when the roller/loader 500 is in the open position. In the example shown, when the roller/loader 500 is in the open position, the first, second, and third parts 560A, 560B, 560C extend over about 180°, however, when the roller/loader 500 is in the closed position, the first, second, and third parts 560A, 560B, 560C extend over about 360°, forming a cylindrical shape with a substantially continuous outer profile (e.g., except at the transitions from the first part 560A to the second and third parts 560B, 560C, respectively, where the diameter of the cylindrical shape changes).

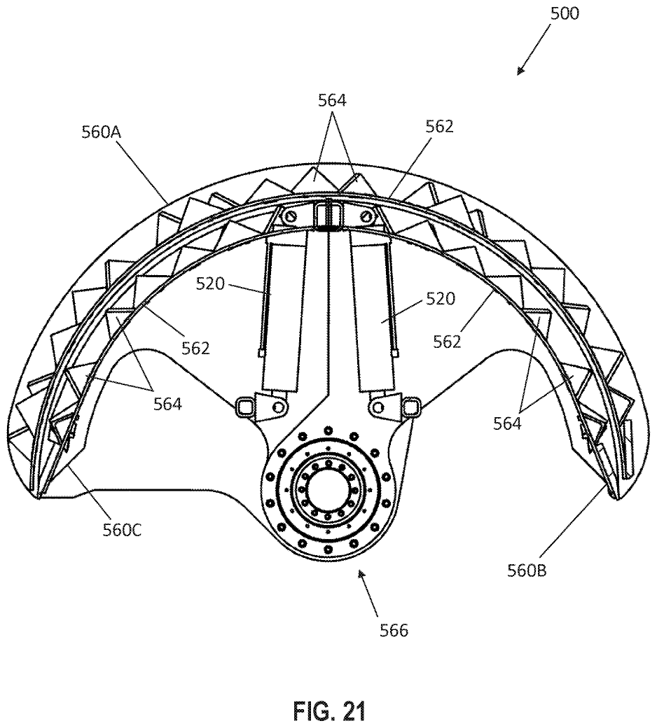

FIG. 20 shows the first, second, and third parts 560A, 560B, 560C in a roller compactor, or closed, configuration. FIG. 21 shows the first, second, and third parts 560A, 560B, 560C in a loader, or open, configuration.

When the roller/loader 500 is being used as a roller for compacting the bulky waste material, the first, second, and third parts 560A, 560B, 560C are positioned in the closed position (see FIG. 20) and rotated in unison with each other. The first, second, and third parts 560A, 560B, 560C each have an outer circumferential surface 562 that extends about the axis of rotation. In the case of the first part 560A, the outer circumferential surface 562 thereof extends about the axis of rotation about 180°. In the case of the second and third parts 560B, 560C, the respective outer circumferential surface 562 thereof extends about the axis of rotation about 90°. The first, second, and third parts 560A, 560B, 560C each have agitators 564 attached over the surface of the circumferential surface 562. The agitators 564 are shaped to compact and shred virtually any type of bulky waste material into smaller pieces that are more readily compressible with smaller total void area (e.g., having a greater density) within the waste collection container 10. The agitators 564 can have any suitable shape and dimensions based on the waste material to be broken apart and/or compacted by the roller/loader 500. The agitators %64 can be attached (e.g., by welding, or during additive manufacturing of the first, second, and third parts 560A, 560B, 560C) to the outer surface 562 of the first, second, and third parts 560A, 560B, 560C in any suitable quantity and arrangement. In some embodiments, the agitators 564 can be formed in a unitary manner with the circumferential surface 562 of the first, second, and third parts 560A, 560B, 560C. In some embodiments, the agitators 564 can be omitted from the surface of the first, second, and third parts 560A, 560B, 560C. In some such embodiments, the agitators 564 can be replaced with a textured (i.e., unevenly shaped, such as in the manner of a series of pyramidally-shaped protrusions) surface over the circumferential surface 562.

The movement of the second part 560B relative to the first part 560A and of the third part 560C relative to the first part 560A is controlled, in the example shown, by respective actuators 520. In the example shown, the actuators 520 are linear actuators, which can be operated, for example and without limitation, pneumatically and/or hydraulically. The actuators 520 can be operated in unison with each other or independently of each other. The actuators 520 can be operated independently of the motors controlling rotation of the roller/loader 500. In some instances, the actuators 520 can be operated simultaneously with the motors that control rotation of the roller/loader 500, which can advantageously allow for a rotational repositioning of the first part 560A relative to the bulky waste material to be grasped while the second and third parts 560B, 560C are, for example, rotated into the open position to allow for the roller/loader 500 to be used to pick up the bulky waste material. In some embodiments, the roller/loader 500 can be used essentially as a scoop (e.g., for moving particulate material, such as sand, rocks, dirt, etc.) when the second and third parts 560B, 560C are in the open position.

One of the actuators 520 is pivotably attached, at a first end thereof, to the first part 560A and, at a second end thereof, to the second part 560B. The other of the actuators 520 is pivotably attached, at a first end thereof, to the first part 560A and, at a second end thereof, to the third part 560C. The attachment point of the respective actuators 520 to the first part 560A is advantageously at a point at or near a circumferential center point on the first part 560A. The actuators 520 are advantageously attached to respective inner surfaces of, and positioned internal to, the roller/loader 500. In the example shown, the actuators 520 are attached to internal frame elements extending between inner longitudinal surface of the first, second, and third parts 560A, 560B, 560C. In the example shown in FIG. 20, these internal frame elements are in the form of longitudinally-extending beams or bars with a substantially square cross-sectional profile, although any suitable cross-sectional shape may be used without limitation.

The second and third parts 560B, 560C can have one edge thereof that is pointed (see, e.g., FIG. 20, where circumferential edges of the second and third parts 560B, 560C are adjacent to each other) and another edge thereof that is blunt (see, e.g., FIG. 20, the other circumferential edge of the second and third parts 560B, 560C). This pointed edge allows the roller/loader 500 to act as a pincer.

Because the actuators 520 are operable independent of the motor controlling rotation of the roller/loader 500, the first, second, and third parts 560A, 560B, 560C, as well as at least the actuators 520 and the internal frame elements to which the actuators 520 are attached, rotate together as a unit and, as such, may be inverted (e.g., opposite the orientation shown in FIG. 20) or at any angle relative to a gravity vector, as the roller/loader 500 is rotating to compact the bulky waste material. When the roller/loader 500 is being used as a loader or grapple (see FIG. 21), the first part 560A will typically be open to face towards the gravity vector (e.g., towards the bulky waste material to be picked up), such that the grapple or pincer elements formed by the second and third parts 560B, 560C will be positioned rotated within or extending under the first part 560A to open and close to engage with and grasp the bulky waste material by the second and third parts 560B, 560C moving, respectively, between the open position (see FIG. 21) and the closed position (see FIG. 20).

As noted elsewhere herein, the actuators 520 can be hydraulically or pneumatically operated. Thus, a rotary union (e.g., a pneumatic or hydraulic rotary union) or other suitable device can be provided to allow a working fluid (e.g., a hydraulic fluid or pneumatic gas) to pass from hoses along the outer frame of the roller/loader 500 (e.g., the structure by which the roller/loader 500 is attached to the arm 300) to the actuators 520. It is thought that routing the working fluid solely through high pressure hoses is impractical because such hoses would be destroyed as the roller/loader 500 rotated within the external frame by which the roller/loader 500 is attached to the arm 300.

The frame by which the roller/loader 500 is attached to the arm 300 can be substantially similar to the frame of the roller/loader 400, having generally an upper bar (see upper bar 410, FIGS. 6-17), which extends substantially parallel to the axis of rotation of the first, second, and third parts 560A, 560B, 560C, and two arms (see arms 420, FIGS. 6-17), that extend substantially perpendicularly to the direction of extension of the upper bar. The upper bar has a mounting plate (see mounting plate 412, FIGS. 6-17) attached thereto, the mounting plate being configured to rigidly (e.g., immovably) attach the roller/loader 500 to the connector 350 of the arm 300. The arms of the frame can have a base plate (see base plate 422, FIGS. 6-17) and a motor (see motor 450, FIGS. 6-17) attached to a first end of the base plate of one of the arms, the motor being fixedly attached to a driving sprocket (see driving sprocket 452, FIGS. 6-17) to co-rotate together. The same arm to which the motor is attached can also have a driven sprocket (see driven sprocket 440, FIGS. 6-17) that is attached to a second end of the base plate of the same arm. The driven sprocket of this arm is attached to (e.g., rigidly, so as to co-rotate with) one of the mounting portions 510 of the roller/loader 500. Thus, the motor controls rotation of the roller/loader 500, and each of the first, second, and third parts 560A, 560B, 560C to corotate in unison with each other. The rotary power from the motor is transferred between the driving and driven sprockets by, for example, a chain (see chain 430, FIGS. 6-17).

In the example embodiment shown, the first part 560A is rigidly attached to the mounting portions 510, whereas the second and third parts 560B, 560C are rotatably supported (e.g., by bearings) by the mounting portion 510 but can pivot relative to the mounting portion 510. Since the positions of the second and third parts 560B, 560C are respectively maintained relative to the first part 560A by the actuators 520, a rotary input to the first part 560A through one of the mounting portions causes the entire roller/loader 500 to rotate relative to the external frame by which the roller/loader 500 is attached to the arm 300. In some examples, 2 motors may be provided, and each arm of the external frame may have both of the driven and driving sprockets connected by the chain. In such examples, the 2 motors are advantageously operated in unison with each other to provide redundant operation of the roller/loader 500.

The second and third parts 560B, 560C have cavities formed in the longitudinally opposing sidewalls thereof that define a recess, generally designated 570. The first part 570A is attached to the driven sprocket(s) and, thus, to the motor(s) by a respective inner plate, generally designated 566. The actuators 520 control a position of the second and third parts 560B, 560C relative to the first part 560A. The inner volume of the first, second, and third parts 560A, 560B, 560C is substantially empty (e.g., at least 90% by volume) and there is no axle or other longitudinal member passing through the roller/loader 500, between the mounting points 510, at least not beyond the inner plates 566. The first part 460A and, thus also, the second and third parts 560B, 560C pivotably attached to the first part 560A by at least the actuators 520, rotate(s) about an axis of rotation defined through mounting points 510. The first, second, and third parts 560A, 560B, 560C can rotate in either direction about the axis of rotation.

The second and third parts 560B, 560C rotate between the closed position and the open position. For the roller/loader 500 to be used as a roller compactor, the second and third parts 560B, 560C are in the closed position shown. For the roller/loader 500 to be used as a waste loader, the second and third parts 560B, 560C are moved away from the closed position, forming a void between the open ends of the second and third parts 560B, 560C, so that the second and third parts 560B, 560C can be engaged around the waste material and the second and third parts 560B, 560C can be rotated towards the closed position to grasp the waste material both within the volume defined by the first, second, and third parts 560A, 560B, 560C and also between the edges of the second and third parts 560B, 560C. The roller/loader 500 can then, once engaged with the waste material, lift the waste material into the waste collection container 10.

Each of the first, second, and third parts 560A, 560B, 560C has outer, radially extending rings on the outer edges thereof that extend beyond the agitators 464 to protect the dumpster or waste collection container 10 from damage by preventing the agitators 464 from touching the bottom and/or side walls of the dumpster or waste collection container 10 as the first, second, and third parts 560A, 560B, 560C in the closed position are used to roll back and forth over waste material for compacting and breaking apart the waste material. Because the second and third parts 560B, 560C rotate within the first part 560A, the first, second, and third parts 560A, 560B, 560C do not form a perfect circle in even the closed position. As such, the edges at the circumferential terminal ends of the first part 560A are tapered to form a substantially continuous (e.g., not stepped) transition between the different radii of the first part 460A and the second and third parts 560B, 560C, where the second and third parts 560B, 560C meet, respectively, the first part 560A when the second and third parts 560B, 560C are in the closed position. This smoothed transition between the edges of the first, second, and third parts 560A, 560B, 560C provides for smoother rolling, while also minimizing the risk of the first part 560A gouging the dumpster or waste collection container 10 and, further, also minimizes the risk of waste material snagging the ends of the outer, radially extending rings of the first, second, and third parts 560A, 560B, 560C.

A reinforcement (e.g., a V-shaped reinforcement) is attached longitudinally to the pointed edges of each of the second and third parts 560B, 560C at the circumferential terminal ends thereof that are adjacent to each other when in the closed position, so as to protect these edges from bending when the roller/loader 500 is used as a waste loader to pick up heavy objects, in which case the mass of such heavy objects may be concentrated near the center span of the second and third parts 560B, 560C. Thus, the reinforcement acts to reinforce these edges of the second and third parts 560B, 560C and prevent deformation thereof.

In the example embodiment shown, the sides of each of the second and third parts 560B, 560C have the same shapes (e.g., mirrored about a plane of symmetry between the second and third parts 560B, 560C) formed into them so as to form the recess 570, which can be used pick up a multitude of materials as the second and third parts 560B, 560C are rotated towards the closed position. The second and third parts 560B, 560C each have a notch formed in the end walls thereof, shaped like a claw. When the second and third parts 560B, 560C, acting like jaws, are in the open position, the respective notch formed therein facilitates grabbing large objects and bundles of long objects, such as boards, timbers, and tree brush. Closing the second and third parts 560B, 560C together creates a smaller opening which is better for picking up or scooping waste material like bottles and smaller waste that typically falls to the bottom of dumpsters. Further, the second and third parts 560B, 560C can both scoop and rotate to form a clamshell-type bucket to hold small or loose debris.

The cut-outs formed in the respective end walls of the second and third parts 560B, 560C each have an angle (e.g., a right angle or acute angle) that is corner-shaped, which enables the second and third parts 560B, 560C to be used to pick up dumpsters (e.g., 1001, FIG. 18) that are equipped with two handles. As the second and third parts 560B, 560C move towards the closed position with the handles in the recess 570, the handles nest in these corners of the respective cut outs to secure the dumpster for pick up. Further, the dumpster can be dumped simply by rotating the first part 560A in the same direction (e.g., remaining in the closed position).

For transport, the second and third parts 560B, 560C can be moved into the open position to minimize the volume occupied by the roller/loader 500 within the waste collection container 10.

The combined functionality of the roller compactor and the waste loader in the example roller/loaders 400, 500 advantageously provides greater efficiency than using both a roller compactor and a waste loader. An operator can rotate the hemicylindrical parts 460A, 460B of the roller/loader 400 or the first, second, and third parts 560A, 560B, 560C of the roller/loader 500 to use the roller/loader 400, 500 as a waste loader or as a compactor; changing from one configuration to another configuration takes only seconds and can be accomplished merely by rotating the hemicylindrical parts 460A, 460B relative to each other or, for the roller/loader 500, by rotating the second and third parts 560B, 560C relative to the first part 560A, such that waste material can be picked up and deposited within the waste collection container 10 using the waste/loader 400, 500 in the grapple configuration (e.g., by moving the hemicylindrical parts 460A, 460B relative to each other or by moving the second and third parts 560B, 560C relative to the first part 560A), and then immediately compacted using the waste/loader 400, 500 in the roller configuration (e.g., by rotating the hemicylindrical parts 460A, 460B or the second and third parts 560B, 560C into the closed position).

By comparison, using a conventional roller compactor and waste loader requires moving the roller compactor out of the way of the waste loader before the waste loader can be used and, similarly, moving the waste loader out of the way of the roller compactor before the roller compactor can be used, which is a slower process and, therefore, less efficient than using the example roller/loaders 400, 500 disclosed herein. Furthermore, the use of a conventional roller compactor and a conventional waste loader also require separate user controls for the roller compactor and the waste loader, respectively, which increases operational complexity. Also, having a conventional waste loader attached to a different arm from a conventional roller compactor increases cost and complexity even further and is also disadvantageous because the position and type of attachment of these two different arms to the vehicle must be addressed to avoid the arms interfering with each other during use. The use of separate arms for a conventional roller compactor and a conventional waste loader also requires more storage volume within the waste collection container 10 during transit and, therefore, also reduces the payload that the waste collection container 10 can accommodate therein, which in turn reduces operational efficiency.

In some embodiments of the mobile waste system 100, the roller/loaders 400, 500 can be used, when in the roller configuration (see, e.g., FIGS. 6-9), to expel the waste material from the waste collection container 10 by rotating the hemicylindrical parts 460A, 460B or, for the roller/loader 500, the first, second, and third parts 560A, 560B, 560C in unison within the waste collection container 10 against the waste material contained therein, the direction of rotation being in the direction that drives the waste material being contacted by the hemicylindrical parts 460A, 460B or, as the case may be, the first, second, and third parts 560A, 560B, 560C, towards the exit (e.g., door at the rear of) of the waste collection container 10. In some such embodiments, the roller/loader 400, 500 can be used in the waste loader configuration shown in FIGS. 10-13 and 14-17 and in the roller configuration shown in FIGS. 6-9 in an alternating manner. For example, the roller/loader 400, 500 can be used in the waste loader configuration to pile or otherwise group or collect the waste material into sufficiently large quantities and then can be used in the roller configuration to expel the collected waste material from the waste collection container 10. This process can be repeated as necessary until substantially all (e.g., at least 75%, at least 80%, at least 90%, at least 95%) of the waste material has been expelled from the waste collection container 10.

In some embodiments of the mobile waste system 100, the roller/loader 400, 500 can be used by positioning the hemicylindrical parts 460A, 460B or the second and third parts 560B, 560C in the open position (see, e.g., FIGS. 14-17, 21) and then using the roller/loader 400, 500 as a pushing implement, similar in operation to that of a bulldozer, such that the arm 300 manipulates the hemicylindrical parts 460A, 460B or, for the roller loader 500, the first, second, and third parts 560A, 560B, 560C, to push the waste material out of the waste collection container 10. This bulldozer configuration for the roller/loader 400, 500 is similar in effect to a conventional horizontal compactor. In instances where the roller/loader 400, 500 is used in the bulldozer configuration and the arm 300 detects that the waste material is not moving for whatever reason, the hemicylindrical parts 460A, 460B of the roller/loader 400 or the second and third parts 560B, 560C of the roller/loader 500 can be rotated towards (but not necessarily fully into) the roller configuration (see, e.g., FIGS. 6-9) to act as a grapple, grasping a portion of the waste material within the internal space defined between the hemicylindrical parts 460A, 460B or, for the roller/loader 500, between the first, second, and third parts 560A, 560B, 560C, and then lifting this waste material and depositing it outside of the waste collection container. The arm 300 can then again try, with the hemicylindrical parts 460A, 460B of the roller/loader 400 (or, for the roller/loader 500, the second and third parts 560B, 560C) in the bulldozer configuration, to use the roller/loader 400, 500 to push the smaller quantity of waste material out of the waste collection container 10. If the arm 300 again detects that the waste material is not moving, the process can be repeated as many times as is necessary until the quantity of waste material is sufficiently small to be moved by the arm 300 with the hemicylindrical parts 460A, 460B of the roller/loader 400 (or the second and third parts 560B, 560C of the roller/loader 500) in the bulldozer configuration.

The roller/loader 400 can also rotate the hemicylindrical parts 460A, 460B in unison while in the bulldozer configuration so that the roller/loader 400 could act as a scoop to lift the waste material. Furthermore, in instances where the arm 300 determines that the waste material is not moving despite the roller/loader 400 being in the bulldozer configuration, the hemicylindrical parts 460A, 460B may be rotated into the roller configuration and used to break apart the waste material, then move back into the bulldozer configuration and continue pushing the waste material out of the waste collection container 10.

Similarly, the roller/loader 500 can also rotate the first, second, and third parts 560A, 560B, 560C in unison while in the bulldozer configuration so that the roller/loader 500 could act as a scoop to lift the waste material. Furthermore, in instances where the arm 300 determines that the waste material is not moving despite the roller/loader 500 being in the bulldozer configuration, the second and third parts 560B, 560C may be rotated into the roller configuration and used to break apart the waste material, then move back into the bulldozer configuration and continue pushing the waste material out of the waste collection container 10.

In some embodiments, the roller/loader 400, 500 can be configured as a standalone attachment that can be attached to any compatible arm or other suitable structure.

In some embodiments of the mobile waste system 100, the waste collection container 100 comprises, at a rear surface (e.g., a surface that is opposite the surface closest to the passenger cab of the transport truck 1) thereof, a door that is pivotably attached to the waste collection container. This door may be attached to the waste collection container 10 such that the door pivots around a vertical axis or a horizontal axis. In some such embodiments, the door may comprise segments that pivots around a vertical axis, the door may be in the form of multiple door segments that are hingedly attached to each other. In an illustrative example, the door may have 2 door segments that are stacked vertically on top of each other and hingedly attached to each other along a horizontal axis. Thus, the top door segment can be pivoted down so that the height of the door is effectively reduced by about 50%. This can advantageously allow for the roller/loader 400, 500 to not have to lift waste material over the top edge of the door when loading or unloading the waste material into/out of the waste collection container 10, thus reducing the amount of time needed to load or unload the waste material into/out of the waste collection container 10. After the level of the waste material within the waste collection container has reached as high as the top edge of the door in the folded configuration, the upper door segment can be pivoted into the deployed position to return the door to its full height and the loading of the waste material can continue. In instances in which the door pivots around a vertical axis and has a bi-fold construction, the hinges connecting the door to the waste collection container 10 can be provided only on the bottom door segment.

In some embodiments of the mobile waste system 100, the arm 300 can be attached to the waste collection container 10 (e.g., at an upper edge thereof), such that the boom arm 310 is attached to the waste collection container 10 at a position that allows for the boom arm 310 to pivot in a vertically-extending plane and swivel in a horizontally-extending plane. In some such embodiments, the waste collection container 10 can be separate from the transport truck 1, for example, in a manner that allows for the waste collection container 10 to be loaded onto and unloaded from the transport truck 1.

In some embodiments of the mobile waste system 100, the arm 300 can be attached directly to the transport truck 1, for example, to the frame 2 of the transport truck 1. In some such embodiments, the boom arm 310 of the arm 300 can be attached to the frame 2 of the transport truck 1 at a position between the passenger cabin of the transport truck 1 and the waste collection container 10, in a manner that allows for the boom arm 310 to swivel in a horizontally-extending plane (e.g., about a vertical axis) and, optionally, to pivot in a vertically-extending plane (e.g., left and right in the view shown in FIG. 3).

While the present disclosure refers to certain examples, numerous modifications, alterations, and changes to the described examples are possible without departing from the sphere and scope of the present disclosure. Accordingly, it is intended that the present disclosure not be limited to the described examples, but that it has the full scope defined by the language of the specification, and equivalents thereof, as would be understood by persons having ordinary skill in the art. The discussion of any example is meant only to be explanatory and is not intended to suggest that the scope of the disclosure, including the claims, is limited to these examples. In other words, while illustrative examples of the disclosure have been described in detail herein, it is to be understood that the inventive concepts may be otherwise variously embodied and employed, and that the descriptions of such examples herein are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more examples or configurations for the purpose of streamlining the disclosure. However, it should be understood that various features of the certain examples or configurations of the disclosure may be combined in alternate examples, or configurations. Any example or feature of any section, portion, or any other component shown or particularly described in relation to various examples of similar sections, portions, or components herein may be interchangeably applied to any other similar example or feature shown or described herein. Additionally, components with the same name may be the same or different, and one of ordinary skill in the art would understand each component could be modified in a similar fashion or substituted to perform the same function.

As used herein, an element or step recited in the singular and proceeded with the word “a” or “an” should be understood as not excluding plural elements or steps, unless such exclusion is explicitly recited. Furthermore, references to “one example” of the present disclosure are not intended to be interpreted as excluding the existence of additional examples that also incorporate the recited features.

The phrases “at least one,” “one or more,” and “and/or” as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

The description herein describes embodiments of the presently disclosed subject matter, and in some cases notes variations and permutations of such embodiments. This description is merely exemplary of the numerous and varied embodiments. The description or mentioning of one or more representative features of a given embodiment is likewise exemplary. Such an embodiment can typically exist with or without the feature(s) mentioned; likewise, all of the features disclosed in each of the example embodiments can be applied to any of the other example embodiments disclosed herein without limitation and without regard to whether the combination of such features is expressly described herein, unless a preclusion against the combination of such features is expressly noted herein.

It will be understood that various details of the presently disclosed subject matter may be changed without departing from the scope of the presently disclosed subject matter. Furthermore, the foregoing description of the example embodiments disclosed herein is only provided for the purpose of illustration only and is not to be used to limit in any way the scope of the subject matter disclosed herein.

1. A combined roller/loader tool comprising:
a first part that is substantially hemicylindrically-shaped and has an outer circumferential surface;
a second part that is substantially hemicylindrically-shaped and has an outer circumferential surface; and
a rigid frame;
wherein the first part and the second part are both rotatably connected to the rigid frame;
wherein, when the first part and the second part are in a closed position, the combined roller/loader tool is configured as a roller compactor, the outer circumferential surface of the first part and the outer circumferential surface of the second part forming a shape that is substantially cylindrical and the first and second parts rotate together in unison to break apart, shred, and/or compact waste material; and
wherein, when the first part and the second part are in an open position, the combined roller/loader tool is configured as a waste loader, the first part and the second part being rotated relative to each other to form a gap between edges of the outer circumferential surfaces of the first and second parts, the first and second parts being configured to rotate from the open position towards the closed position to engage the waste material within a volume defined internal to the first and second parts and/or to hold the waste material between the edges of the outer circumferential surfaces of the first and second parts in a direction of rotation from the open position to the closed position.

2. The combined roller/loader tool of claim 1, wherein the first part has a radius that is smaller than a radius of the second part.

3. The combined roller/loader tool of claim 2, wherein the first part, in moving from the closed position to the open position, rotates radially inside the second part.

4. The combined roller/loader tool of any of claims 1-3, wherein the outer circumferential edge of the first part and the outer circumferential edge of the second part both extend circumferentially to each define at least 180°of the substantially cylindrical shape formed by the first and second parts when in the closed position.

5. The combined roller/loader tool of any of claims 1-4, wherein:
the outer circumferential surface of the first part comprises agitators rigidly attached thereto;
the outer circumferential surface of the second part comprises agitators rigidly attached thereto; and
the agitators of the first and second parts are configured to break apart, shred, and/or compact the waste material.

6. The combined roller/loader tool of any of claims 1-5, wherein:
the first part comprises end plates that are attached to the outer circumferential surface of the first part at opposing longitudinal ends of the outer circumferential surface thereof; and
the second part comprises end plates that are attached to the outer circumferential surface of the second part at opposing longitudinal ends of the outer circumferential surface thereof.

7. The combined roller/loader tool of claim 6, wherein the first and second parts each have a radially extending wall at each of the longitudinal ends thereof, the radially extending wall extending beyond the agitators of the first and second parts, respectively, to prevent the agitators from contacting a surface of a waste collection container or dumpster while the combined roller/loader tool is being used as the roller compactor in the closed position.

8. The combined roller/loader tool of claims 6 or 7, wherein:
the end plates of the first part have a cut-out section;
the end plates of the second part have a cut-out section; and
the cut-out section of the first part is a different size and/or shape than the cut-out section of the second part; or
the cut-out section of the first part is a same size and/or shape as the cut-out section of the second part.

9. The combined roller/loader tool of claim 8, wherein the cut-out section of the first part and the cut-out section of the second part are aligned with each other such that, when the first and second parts are in the closed position, the cut-out section of the first part and the cut-out section of the second part form a substantially continuous recess.

10. The combined roller/loader tool of claim 9, wherein the recess is shaped such that handles of a container can be secured within the recess formed by the end plates of the first and second parts when the first and second parts are in the closed position.

11. The combined roller/loader tool of claim 1, comprising:
a first actuator attached to the first part, wherein the first actuator is configured to pivotably move or rotate the first part about an axis of rotation; and
a second actuator attached to the second part, wherein the second actuator is configured to pivotably move or rotate the second part about the axis of rotation.

12. The combined roller/loader tool of claim 11, wherein:
the first actuator is an electric motor or a hydraulic motor; and
the second actuator is an electric motor or a hydraulic motor.

13. The combined roller/loader tool of claim 11 or 12, wherein:
the first actuator is connected directly to the first part; and
the second actuator is connected directly to the second part.

14. The combined roller/loader tool of claim 11 or 12, wherein:
the first actuator is connected indirectly to the first part; and
the second actuator is connected indirectly to the second part.

15. The combined roller/loader tool of claim 14, wherein:
the first actuator is connected to the first part by a chain; and
the second actuator is connected to the second part by a chain.

16. The combined roller/loader tool of any of claims 11-15, wherein:
the first and second actuators are controlled independently of each other; or the first and second actuators are controlled to move in unison with each other.

17. An arm comprising, attached at a mobile end of the articulating arm, the combined roller/loader tool of any of claims 1-16.

18. The arm of claim 17, wherein the arm comprises a plurality of arm segments.

19. The arm of claim 18, wherein the plurality of arm segments are one or more of telescoping arm segments or articulating arm segments.

20. A waste collection container that is substantially rigid and the arm of any of claims 17-19, wherein the combined roller/loader tool is configured for selective use as:
the roller compactor to break apart, shred, and/or compact the bulky waste material in the waste collection container; and
the waste loader to move the bulky waste material into the waste collection container and/or remove the bulky waste material from the waste collection container.

21. The waste collection container of claim 20, wherein the arm is fixedly and/or pivotably attached to the waste collection container, so that the arm cannot move in a translatory manner relative to the waste collection container.

22. The waste collection container of claim 20, wherein the arm is attached to the waste collection container in a mobile manner.

23. The waste collection container of claim 22, wherein the mobile manner in which the arm is attached to the waste collection container comprises a mobile platform that is movable at least along a length of the waste collection container.

24. The waste collection container of claim 23, wherein the arm is rotatable and/or pivotable relative to the mobile platform.

25. The waste collection container of claim 23 or 24, wherein the mobile platform can move the arm along an entirety of the length of the waste collection container.

26. A mobile waste system comprising a transport truck and the waste collection container of any of claims 20-25, wherein the waste collection container is attached to the transport truck.

27. A mobile waste system comprising a transport truck and the waste collection container of claim 20, wherein the arm is fixedly and/or pivotably attached to the transport truck, so that the arm cannot move in a translatory manner relative to the transport truck.

28. The mobile waste system of claim 27, wherein the arm is attached to a frame of the transport truck, at a position that is between the waste collection container and a passenger cabin of the transport truck.

29. The mobile waste system of claim 28, wherein the arm is attached directly to the frame of the transport truck.

30. A mobile waste system comprising a transport truck and the arm of any of claims 17-19, wherein the arm is attached to the transport truck and the mobile waste system is configured to selectively use the combined roller/loader tool as:
the roller compactor to break apart, shred, and/or compact a bulky waste material in a waste collection container; and
the waste loader to move the bulky waste material into the waste collection container and/or remove the bulky waste material from the waste collection container.

31. The mobile waste system of claim 30, wherein the arm is fixedly and/or pivotably attached to the transport truck, so that the arm cannot move in a translatory manner relative to the transport truck.

32. The mobile waste system of claim 31, wherein the arm is attached to a frame of the transport truck.

33. The mobile waste system of claim 32, wherein the arm is attached directly to the frame of the transport truck.

34. A combined roller/loader tool comprising:
a first part that is substantially hemicylindrically-shaped and has an outer circumferential surface;
a second part that has a shape of a quarter cylinder and has an outer circumferential surface;
a third part that has a shape of a quarter cylinder and has an outer circumferential surface; and
a rigid frame;
wherein the second and third parts are each pivotably attached to the first part and movable into and between a closed position, in which the combined roller/loader is configured as a roller compactor, and an open position, in which the combined roller/loader is configured as a waste loader or grapple;
wherein the first part is rotatably connected to the rigid frame, such that the first, second, and third parts rotate about a common axis of rotation in unison with each other;
wherein, when the second part and the third part are in the closed position and the combined roller/loader tool is configured as the roller compactor:
the outer circumferential surface of the first part, the outer circumferential surface of the second part, and the outer circumferential surface of the third part together form a shape that is substantially cylindrical; and
the first, second, and third parts are configured to rotated together in unison to break apart, shred, and/or compact a bulky waste material; and
wherein, when the second part and the third part are in the open position and the combined roller/loader tool is configured as the waste loader:
the second part and the third part are each rotated relative to the first part to form a gap between adjacent edges of the outer circumferential surfaces of the second and third parts; and
the second and third parts are configured to rotate from the open position towards the closed position to engage the waste material within a volume defined internal to the first, second, and third parts and/or to hold the waste material between the edges of the outer circumferential surfaces of the second and third parts in a direction of rotation from the open position to the closed position.

35. The combined roller/loader tool of claim 34, wherein the second and third parts each have a radius that is smaller than a radius of the first part.

36. The combined roller/loader tool of claim 35, wherein the second and third parts, in moving from the closed position to the open position, both rotate radially inside the first part.

37. The combined roller/loader tool of claim 36, wherein, in rotating radially inside the first part, the second and third parts rotate in opposite directions from each other.

38. The combined roller/loader tool of claim 37, wherein the opposite directions are clockwise and anticlockwise.

39. The combined roller/loader tool of any of claims 34-38, wherein:
the outer circumferential edge of the first part extends circumferentially to define about 180° of the substantially cylindrical shape;
the outer circumferential edge of the second part extends circumferentially to define about 90° of the substantially cylindrical shape; and
the outer circumferential edge of the third part extends circumferentially to define about 90° of the substantially cylindrical shape.

40. The combined roller/loader tool of any of claims 34-38, wherein, when in the closed position, the outer circumferential edge of the first part, the outer circumferential edge of the second part, and the outer circumferential edge of the third part together extend over at least 330°.

41. The combined roller/loader tool of any of claims 34-38, wherein, when in the closed position, the outer circumferential edge of the first part, the outer circumferential edge of the second part, and the outer circumferential edge of the third part together extend over about 360°.

42. The combined roller/loader tool of any of claims 34-41, wherein:
the outer circumferential surface of the first part comprises agitators rigidly attached thereto;
the outer circumferential surface of the second part comprises agitators rigidly attached thereto;
the outer circumferential surface of the third part comprises agitators rigidly attached thereto; and
the agitators of the first, second, and third parts are configured to break apart, shred, and/or compact the waste material.

43. The combined roller/loader tool of any of claims 34-42, wherein:
the first part comprises end plates that are attached to the outer circumferential surface of the first part at opposing longitudinal ends of the outer circumferential surface thereof;
the second part comprises end plates that are attached to the outer circumferential surface of the second part at opposing longitudinal ends of the outer circumferential surface thereof; and
the third part comprises end plates that are attached to the outer circumferential surface of the third part at opposing longitudinal ends of the outer circumferential surface thereof.

44. The combined roller/loader tool of claim 43, wherein the first, second, and third parts each have a radially extending wall at each of the longitudinal ends thereof, the radially extending wall extending beyond the agitators of the first, second, and third parts, respectively, to prevent the agitators from contacting a surface of a waste collection container or dumpster while the combined roller/loader tool is being used as the roller compactor in the closed position.

45. The combined roller/loader tool of claims 43 or 44, wherein:
the end plates of the second part have a cut-out section;
the end plates of the third part have a cut-out section; and
the cut-out section of the second part is a different size and/or shape than the cut-out section of the third part; or
the cut-out section of the second part is a same size and/or shape as the cut-out section of the third part.

46. The combined roller/loader tool of claim 45, wherein the cut-out section of the second part and the cut-out section of the third part are aligned with each other such that, when the second and third parts are in the closed position, the cut-out section of the second part and the cut-out section of the third part form a substantially continuous recess.

47. The combined roller/loader tool of claim 46, wherein the recess is shaped such that handles of a container can be secured within the recess formed by the end plates of the second and third parts when the second and third parts are in the closed position.

48. The combined roller/loader tool of claim 34, comprising:
a first actuator attached, at a first end, to the first part and, at a second end, to the second part, wherein the first actuator is configured to pivotably move or rotate the second part relative to the first part; and
a second actuator attached, at a first end, to the first part and, at a second end, to the third part, wherein the second actuator is configured to pivotably move or rotate the third part relative to the first part.

49. The combined roller/loader tool of claim 48, wherein:
the first actuator is a linear actuator that pivotably moves the second part relative to the first part by changing a length of the first actuator; and
the second actuator is a linear actuator that pivotably moves the third part relative to the first part by changing a length of the second actuator.

50. The combined roller/loader tool of claim 49, wherein the first actuator and the second actuator are each a hydraulic, pneumatic, or electric linear actuator.

51. The combined roller/loader tool of any of claims 48-50, wherein:
the first and second actuators are controlled independently of each other; or
the first and second actuators are controlled to move in unison with each other.

52. An arm comprising, attached at a mobile end of the articulating arm, the combined roller/loader tool of any of claims 34-51.

53. The arm of claim 52, wherein the arm comprises a plurality of arm segments.

54. The arm of claim 53, wherein the plurality of arm segments are one or more of telescoping arm segments or articulating arm segments.

55. A waste collection container that is substantially rigid and the arm of any of claims 52-54, wherein the combined roller/loader tool is configured for selective use as:
the roller compactor to break apart, shred, and/or compact the waste material in the waste collection container; and
the waste loader to move the bulky waste material into the waste collection container and/or remove the bulky waste material from the waste collection container.

56. The waste collection container of claim 55, wherein the arm is fixedly and/or pivotably attached to the waste collection container, so that the arm cannot move in a translatory manner relative to the waste collection container.

57. The waste collection container of claim 55, wherein the arm is attached to the waste collection container in a mobile manner.

58. The waste collection container of claim 57, wherein the mobile manner in which the arm is attached to the waste collection container comprises a mobile platform that is movable at least along a length of the waste collection container.

59. The waste collection container of claim 58, wherein the arm is rotatable and/or pivotable relative to the mobile platform.

60. The waste collection container of claim 58 or 59, wherein the mobile platform can move the arm along an entirety of the length of the waste collection container.

61. A mobile waste system comprising a transport truck and the waste collection container of any of claims 55-60, wherein the waste collection container is attached to the transport truck.

62. A mobile waste system comprising a transport truck and the waste collection container of claim 55, wherein the arm is fixedly and/or pivotably attached to the transport truck, so that the arm cannot move in a translatory manner relative to the transport truck.

63. The mobile waste system of claim 62, wherein the arm is attached to a frame of the transport truck, at a position that is between the waste collection container and a passenger cabin of the transport truck.

64. The mobile waste system of claim 63, wherein the arm is attached directly to the frame of the transport truck.

65. A mobile waste system comprising a transport truck and the arm of any of claims 52-54, wherein the arm is attached to the transport truck and the mobile waste system is configured to selectively use the combined roller/loader tool as:
the roller compactor to break apart, shred, and/or compact a bulky waste material in a waste collection container; and
the waste loader to move the bulky waste material into the waste collection container and/or remove the bulky waste material from the waste collection container.

66. The mobile waste system of claim 65, wherein the arm is fixedly and/or pivotably attached to the transport truck, so that the arm cannot move in a translatory manner relative to the transport truck.

67. The mobile waste system of claim 66, wherein the arm is attached to a frame of the transport truck.

68. The mobile waste system of claim 67, wherein the arm is attached directly to the frame of the transport truck.

69. A method of using a combined roller/loader tool to selectively compact and move a bulky waste material, the method comprising:
attaching a first part that is substantially hemicylindrically-shaped and a second part that is substantially hemicylindrically-shaped to a rigid frame, wherein the first part has an outer circumferential surface and the second part has an outer circumferential surface;
rotating the first part and the second part into a closed position, in which the combined roller/loader tool is operable as a roller compactor, such that the outer circumferential surface of the first part and the outer circumferential surface of the second part forming a shape that is substantially cylindrical;
rotating, while the first and second parts are in the closed position, the first and second parts together in unison to break apart, shred, and/or compact waste material;
rotating the first part and the second part into or towards an open position, in which the first part and the second part form a gap between edges of the outer circumferential surfaces of the first and second parts, wherein, when the first and second parts are not in the closed position, the combined roller/loader tool is operable as a waste loader; and
rotating, while the first and second parts are not in the closed position, the first and second parts relative to each other between the open and closed positions to engage the waste material within a volume defined internal to the first and second parts and/or to hold the waste material between the edges of the outer circumferential surfaces of the first and second parts in a direction of rotation from the open position to the closed position.

70. The method of claim 69, wherein the first part has a radius that is smaller than a radius of the second part.

71. The method of claim 70, wherein the first part, in moving from the closed position to the open position, rotates radially inside the second part.

72. The method of any of claims 69-71, wherein the outer circumferential edge of the first part and the outer circumferential edge of the second part both extend circumferentially to each define at least 180°of the substantially cylindrical shape formed by the first and second parts when in the closed position.

73. The method of any of claims 69-72, wherein:
the outer circumferential surface of the first part comprises agitators rigidly attached thereto;
the outer circumferential surface of the second part comprises agitators rigidly attached thereto; and
the agitators of the first and second parts are used to break apart, shred, and/or compact the waste material.

74. The method of any of claims 69-73, wherein:
the first part comprises end plates that are attached to the outer circumferential surface of the first part at opposing longitudinal ends of the outer circumferential surface thereof; and
the second part comprises end plates that are attached to the outer circumferential surface of the second part at opposing longitudinal ends of the outer circumferential surface thereof.

75. The method of claim 74, wherein the first and second parts each have a radially extending wall at each of the longitudinal ends thereof, the radially extending wall extending beyond the agitators of the first and second parts, respectively, to prevent the agitators from contacting a surface of a waste collection container or dumpster while the combined roller/loader tool is being used as the roller compactor in the closed position.

76. The method of claims 74 or 75, wherein:
the end plates of the first part have a cut-out section;
the end plates of the second part have a cut-out section; and
the cut-out section of the first part is a different size and/or shape than the cut-out section of the second part; or
the cut-out section of the first part is a same size and/or shape as the cut-out section of the second part.

77. The method of claim 76, wherein the cut-out section of the first part and the cut-out section of the second part are aligned with each other such that, when the first and second parts are in the closed position, the cut-out section of the first part and the cut-out section of the second part form a substantially continuous recess.

78. The method of claim 77, wherein the recess is shaped such that handles of a container can be secured within the recess formed by the end plates of the first and second parts when the first and second parts are in the closed position.

79. The method of claim 69, comprising:
attaching a first actuator to the first part;
attaching a second actuator to the second part;
using the first actuator to pivotably move or rotate the first part about an axis of rotation; and
using the second actuator to pivotably move or rotate the second part about the axis of rotation.

80. The method of claim 79, wherein:
the first actuator is an electric motor or a hydraulic motor; and
the second actuator is an electric motor or a hydraulic motor.

81. The method of claim 79 or 80, wherein:
the first actuator is connected directly to the first part; and
the second actuator is connected directly to the second part.

82. The method of claim 79 or 80, wherein:
the first actuator is connected indirectly to the first part; and
the second actuator is connected indirectly to the second part.

83. The method of claim 82, wherein:
the first actuator is connected to the first part by a chain; and
the second actuator is connected to the second part by a chain.

84. The method of any of claims 79-83, wherein:
the first and second actuators are controlled independently of each other; or
the first and second actuators are controlled to move in unison with each other.

85. The method of any of claims 69-84, comprising attaching the combined roller/loader tool at a mobile end of an articulating arm.

86. The method of claim 85, wherein the arm comprises a plurality of arm segments.

87. The method of claim 86, wherein the plurality of arm segments are one or more of telescoping arm segments or articulating arm segments.

88. The method of any of claims 85-87, comprising selectively using the arm and the combined roller/loader tool as:
the roller compactor to break apart, shred, and/or compact a bulky waste material in a waste collection container that is substantially rigid; and
the waste loader to move the bulky waste material into the waste collection container and/or remove the bulky waste material from the waste collection container.

89. The method of claim 88, comprising fixedly and/or pivotably attaching the arm to the waste collection container, so that the arm cannot move in a translatory manner relative to the waste collection container.

90. The method of claim 88, comprising attaching the arm to the waste collection container in a mobile manner.

91. The method of claim 90, wherein the mobile manner in which the arm is attached to the waste collection container comprises a mobile platform, the method comprising moving the mobile platform at least along a length of the waste collection container.

92. The method of claim 91, comprising rotating and/or pivoting the arm relative to the mobile platform.

93. The method of claim 91 or 92, comprising using the mobile platform to move the arm along an entirety of the length of the waste collection container.

94. The method of any of claims 85-93, comprising attaching the waste collection container to a transport truck.

95. The method of claim 88, comprising fixedly and/or pivotably attaching the arm to a transport truck, so that the arm cannot move in a translatory manner relative to the transport truck.

96. The method of claim 95, wherein the arm is attached to a frame of the transport truck, at a position that is between the waste collection container and a passenger cabin of the transport truck.

97. The method of claim 96, wherein the arm is attached directly to the frame of the transport truck.

98. The method of any of claims 85-87, comprising:
attaching the arm to a transport truck; and
selectively using the combined roller/loader tool as:
the roller compactor to break apart, shred, and/or compact a bulky waste material in a waste collection container; and
the waste loader to move the bulky waste material into the waste collection container and/or remove the bulky waste material from the waste collection container.

99. The method of claim 98, wherein the arm is fixedly and/or pivotably attached to the transport truck, so that the arm cannot move in a translatory manner relative to the transport truck.

100. The method of claim 99, wherein the arm is attached to a frame of the transport truck.

101. The method of claim 100, wherein the arm is attached directly to the frame of the transport truck.

102. A method of using a combined roller/loader tool to selectively compact and move a bulky waste material, the method comprising:
pivotably attaching a first part, which is substantially hemicylindrically-shaped and has an outer circumferential surface, to a rigid frame;
pivotably attaching a second part, which has a shape of a quarter cylinder and has an outer circumferential surface, to the first part;
pivotably attaching a third part, which has a shape of a quarter cylinder and has an outer circumferential surface, to the first part;
pivoting or rotating the second and third parts, respectively and relative to the first part, into and between a closed position, in which the combined roller/loader tool can be used as a roller compactor, and an open position, in which the combined roller/loader tool is configured as a waste loader or grapple;
wherein the first part is rotatably connected to the rigid frame, such that the first, second, and third parts rotate about a common axis of rotation in unison with each other;
wherein, when the second part and the third part are in the closed position and the combined roller/loader tool is configured as the roller compactor:
the outer circumferential surface of the first part, the outer circumferential surface of the second part, and the outer circumferential surface of the third part together form a shape that is substantially cylindrical; and
the first, second, and third parts rotate together in unison to break apart, shred, and/or compact a bulky waste material; and
wherein, when the second part and the third part are in the open position and the combined roller/loader tool is configured as the waste loader:
the second part and the third part are each rotated relative to the first part to form a gap between adjacent edges of the outer circumferential surfaces of the second and third parts; and
the second and third parts rotate from the open position towards the closed position to engage the waste material within a volume defined internal to the first, second, and third parts and/or to hold the waste material between the edges of the outer circumferential surfaces of the second and third parts in a direction of rotation from the open position to the closed position.

103. The method of claim 102, wherein the second and third parts each have a radius that is smaller than a radius of the first part.

104. The method of claim 103, wherein the second and third parts, in moving from the closed position to the open position, both rotate radially inside the first part.

105. The method of claim 104, wherein, in rotating radially inside the first part, the second and third parts rotate in opposite directions from each other.

106. The method of claim 105, wherein the opposite directions are clockwise and anticlockwise.

107. The method of any of claims 102-106, wherein:
the outer circumferential edge of the first part extends circumferentially to define about 180° of the substantially cylindrical shape;
the outer circumferential edge of the second part extends circumferentially to define about 90° of the substantially cylindrical shape; and
the outer circumferential edge of the third part extends circumferentially to define about 90° of the substantially cylindrical shape.

108. The method of any of claims 102-106, wherein, when in the closed position, the outer circumferential edge of the first part, the outer circumferential edge of the second part, and the outer circumferential edge of the third part together extend over at least 330°.

109. The method of any of claims 102-106, wherein, when in the closed position, the outer circumferential edge of the first part, the outer circumferential edge of the second part, and the outer circumferential edge of the third part together extend over about 360°.

110. The method of any of claims 102-109, wherein:
the outer circumferential surface of the first part comprises agitators rigidly attached thereto;
the outer circumferential surface of the second part comprises agitators rigidly attached thereto;
the outer circumferential surface of the third part comprises agitators rigidly attached thereto; and
when the second and third parts are in the closed position, the agitators of the first, second, and third parts to break apart, shred, and/or compact the waste material.

111. The method of any of claims 102-110, wherein:
the first part comprises end plates that are attached to the outer circumferential surface of the first part at opposing longitudinal ends of the outer circumferential surface thereof;
the second part comprises end plates that are attached to the outer circumferential surface of the second part at opposing longitudinal ends of the outer circumferential surface thereof; and
the third part comprises end plates that are attached to the outer circumferential surface of the third part at opposing longitudinal ends of the outer circumferential surface thereof.

112. The method of claim 111, wherein the first, second, and third parts each have a radially extending wall at each of the longitudinal ends thereof, the radially extending wall extending beyond the agitators of the first, second, and third parts, respectively, to prevent the agitators from contacting a surface of a waste collection container or dumpster while the combined roller/loader tool is being used as the roller compactor in the closed position.

113. The method of claims 111 or 112, wherein:
the end plates of the second part have a cut-out section;
the end plates of the third part have a cut-out section; and
the cut-out section of the second part is a different size and/or shape than the cut-out section of the third part; or
the cut-out section of the second part is a same size and/or shape as the cut-out section of the third part.

114. The method of claim 113, wherein the cut-out section of the second part and the cut-out section of the third part are aligned with each other such that, when the second and third parts are in the closed position, the cut-out section of the second part and the cut-out section of the third part form a substantially continuous recess.

115. The method of claim 114, wherein the recess is shaped such that handles of a container can be secured within the recess formed by the end plates of the second and third parts when the second and third parts are in the closed position.

116. The method of claim 102, comprising:
attaching a first end of a first actuator to the first part and a second end of the first actuator to the second part;
attaching a first end of a second actuator to the first part and a second end of the second actuator to the third part;
using the first actuator to pivotably move or rotate the second part relative to the first part; and
using the second actuator to pivotably move or rotate the third part relative to the first part.

117. The method of claim 116, wherein:
the first actuator is a linear actuator that pivotably moves the second part relative to the first part by changing a length of the first actuator; and
the second actuator is a linear actuator that pivotably moves the third part relative to the first part by changing a length of the second actuator.

118. The method of claim 117, wherein the first actuator and the second actuator are each a hydraulic, pneumatic, or electric linear actuator.

119. The method of any of claims 116-118, wherein:
the first and second actuators are controlled independently of each other; or
the first and second actuators are controlled to move in unison with each other.

120. The method of any of claims 102-119, comprising attaching the combined roller/loader tool at a mobile end of an articulating arm.

121. The method of claim 120, wherein the arm comprises a plurality of arm segments.

122. The method of claim 121, wherein the plurality of arm segments are one or more of telescoping arm segments or articulating arm segments.

123. The method of any of claims 120-122, comprising selectively using the combined roller/loader tool as:
the roller compactor to break apart, shred, and/or compact the waste material in the waste collection container; and
the waste loader to move the bulky waste material into the waste collection container and/or remove the bulky waste material from the waste collection container.

124. The method of claim 123, comprising fixedly and/or pivotably attaching the arm to the waste collection container, so that the arm cannot move in a translatory manner relative to the waste collection container.

125. The method of claim 123, comprising attaching the arm to the waste collection container in a mobile manner.

126. The method of claim 125, wherein the mobile manner in which the arm is attached to the waste collection container comprises a mobile platform, the method comprising moving the mobile platform at least along a length of the waste collection container.

127. The method of claim 126, comprising rotating and/or pivoting the arm relative to the mobile platform.

128. The method of claim 126 or 127, comprising using the mobile platform to move the arm along an entirety of the length of the waste collection container.

129. The method of any of claims 123-128, comprising attaching the waste collection container to the transport truck.

130. The method of claim 123, comprising fixedly and/or pivotably attaching the arm to a transport truck, so that the arm cannot move in a translatory manner relative to the transport truck.

131. The method of claim 130, wherein the arm is attached to a frame of the transport truck, at a position that is between the waste collection container and a passenger cabin of the transport truck.

132. The method of claim 131, wherein the arm is attached directly to the frame of the transport truck.

133. The method of any of claims 120-122, comprising:
attaching the arm to a transport truck; and
selectively using the combined roller/loader tool as:
the roller compactor to break apart, shred, and/or compact a bulky waste material in a waste collection container; and
the waste loader to move the bulky waste material into the waste collection container and/or remove the bulky waste material from the waste collection container.

134. The method of claim 133, wherein the arm is fixedly and/or pivotably attached to the transport truck, so that the arm cannot move in a translatory manner relative to the transport truck.

135. The method of claim 134, wherein the arm is attached to a frame of the transport truck.

136. The method of claim 135, wherein the arm is attached directly to the frame of the transport truck.
